(19) United States
(12) Patent Application Publication
(10) Pub. No.: US 2025/0189156 A1
(43) Pub. Date: Jun. 12, 2025

(54) AIR CONDITIONER INCLUDING LIGHT AND METHOD OF CONTROLLING THE AIR CONDITIONER

(71) Applicant: SAMSUNG ELECTRONICS CO., LTD., Suwon-si (KR)

(72) Inventors: Jun HWANG, Suwon-si (KR); Donghyun KIM, Suwon-si (KR); Jinwoo HONG, Suwon-si (KR); Yonghee JANG, Suwon-si (KR); Youngju JOO, Suwon-si (KR); Jaehun HUR, Suwon-si (KR)

(21) Appl. No.: 18/977,830

(22) Filed: Dec. 11, 2024

Related U.S. Application Data
(63) Continuation of application No. PCT/KR2024/019370, filed on Nov. 29, 2024.

(30) Foreign Application Priority Data
Dec. 11, 2023 (KR) 10-2023-0178747

(51) Int. Cl. F24F 11/52; F24F 11/38; F24F 110/10; F24F 110/20; F24F 120/10; F24F 130/30; F24F 140/60

(52) U.S. Cl. CPC F24F 11/52; F24F 11/38; F24F 2110/10; F24F 2110/20; F24F 2120/10; F24F 2130/30; F24F 2140/60

(57) ABSTRACT

An air conditioner includes a detection sensor, an illuminance sensor, a light, an air conditioning module, at least one processor, and a memory storing instructions, when executed by the at least one processor individually or collectively, cause the air conditioner to determine whether an illuminance value detected by the illuminance sensor is greater than or equal to a first illuminance reference value, detect a human in a target space by using a sensor detection value of the detection sensor, and based on the detected illuminance value being greater than or equal to the first illuminance reference value and a human being detected in the target space, control the light in a first mode in which at least one of luminous intensity or a luminous intensity change pattern of the light is controlled based on a compressor frequency of the air conditioning module.

### CROSS-REFERENCE TO RELATED APPLICATIONS

This application is a continuation of International Application No. PCT/KR2024/019370 designating the United States, filed on Nov. 29, 2024, in the Korean Intellectual Property Receiving office and claiming priority to Korean Patent Application No. 10-2023-0178747, filed on Dec. 11, 2023, in the Korean Intellectual Property Office, the disclosures of which are incorporated by reference herein in their entireties.

### BACKGROUND

### Technical Field

An embodiment of the disclosure relates to an air conditioner including a light, a method of controlling the air conditioner, and a computer-readable recording medium having recorded thereon a program for causing a computer to perform the method of controlling the air conditioner.

### Background Art

Various types of air conditioners are widely used in indoor spaces. An air conditioner may include various sensors, for example, a human detection sensor, an illuminance sensor, or a temperature sensor. The air conditioner may use various sensors to adjust the environment of an air-conditioned space and control the operation of the air conditioner. In addition, an air conditioner including a light may provide various functions by using the light. However, when the light of the air conditioner is used only for indoor lighting, utilization of the light is reduced.

### SUMMARY

According to an aspect of an embodiment of the disclosure, an air conditioner is provided. The air conditioner includes a detection sensor configured to detect an object, an illuminance sensor configured to detect an illuminance of a target space, a light, an air conditioning module comprising a compressor, at least one processor including processing circuitry, and a memory storing at least one instructions, when executed by the at least one processor individually or collectively, cause the air conditioner to determine whether an illuminance value detected by the illuminance sensor is greater than or equal to a first illuminance reference value, detect a human in the target space by using a sensor detection value of the detection sensor, and based on the detected illuminance value being greater than or equal to the first illuminance reference value and a human being detected in the target space, control the light in a first mode in which at least one of luminous intensity or a luminous intensity change pattern of the light is controlled based on a compressor frequency of the compressor of the air conditioning module.

In addition, according to an aspect of an embodiment of the disclosure, a method of controlling an air conditioner is provided. The method of controlling an air conditioner includes detecting an illuminance value of a target space by using an illuminance sensor, determining whether the detected illuminance value is greater than or equal to a first illuminance reference value, detecting a human in the target space by using a sensor detection value of a detection sensor, and based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.

In addition, according to an aspect of an embodiment of the present disclosure, provided is a computer-readable recording medium having recorded thereon a program for executing, on a computer, the method of controlling an air conditioner by detecting an illuminance value of a target space by using an illuminance sensor; determining whether the detected illuminance value is greater than or equal to a first illuminance reference value; detecting a human in the target space by using a sensor detection value of a detection sensor; and based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.

### BRIEF DESCRIPTION OF THE DRAWINGS

An embodiment of the disclosure may be readily understood with a combination of the following detailed descriptions and the accompanying drawings, wherein reference numbers refer to structural elements.

FIG. 1 is a diagram illustrating an operation of an air conditioner according to an embodiment of the disclosure.

FIG. 2 is a diagram illustrating a structure of an air conditioner according to an embodiment of the disclosure.

FIG. 3 is a flowchart of a method of controlling an air conditioner, according to an embodiment of the disclosure.

FIG. 4 is a flowchart of a method of controlling an air conditioner, according to an embodiment of the disclosure.

FIG. 5 is a diagram illustrating operations in a first mode and a second mode, according to an embodiment of the disclosure.

FIG. 6 is a diagram illustrating an operation of an air conditioner in a first mode, according to an embodiment of the disclosure.

FIG. 7 is a diagram illustrating a process of controlling a light in a first mode, according to an embodiment of the disclosure.

FIG. 8 is a diagram illustrating a process of controlling a light in a first mode, according to an embodiment of the disclosure.

FIG. 9 is a diagram illustrating a process of controlling a light in a first mode, according to an embodiment of the disclosure.

FIG. 10 is a diagram illustrating a process of controlling a light in a first mode, according to an embodiment of the disclosure.

FIG. 11 is a diagram illustrating a process of controlling a light in a first mode, according to an embodiment of the disclosure.

FIG. 12 is a diagram illustrating a process of controlling a light in a first mode, according to an embodiment of the disclosure.

FIG. 13 is a block diagram illustrating a structure of an air conditioner according to an embodiment of the disclosure.

FIG. 14 is a diagram showing power consumption learned according to environmental information, according to an embodiment of the disclosure.

FIG. 15 is a diagram illustrating an air conditioner, an external device, and a server, according to an embodiment of the disclosure.

FIG. 16 is a diagram illustrating an operation of providing an abnormal operation notification, according to an embodiment of the disclosure.

FIG. 17 is a flowchart of a method of controlling an air conditioner, according to an embodiment of the disclosure.

FIG. 18 is a diagram illustrating an operation of an air conditioner when a new user is detected in a target space, according to an embodiment of the disclosure.

### DETAILED DESCRIPTION

It should be appreciated that various embodiments of the disclosure and the terms used therein are not intended to limit the technological features set forth herein to particular embodiments, and include various changes, equivalents, or alternatives for a corresponding embodiment.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, the term “and/or” includes any one or a combination of a plurality of related recited elements.

As used herein, such terms as “1st” and “2nd,” or “first” and “second” may be used to simply distinguish a corresponding component from another, and does not limit the components in other aspect (e.g., importance or order).

When an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

As used here, such terms as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

An air conditioner according to an embodiment of the disclosure is a device configured to perform functions such as air purification, ventilation, humidity control, cooling, or heating in an air-conditioned space (hereinafter, referred to as “indoor space”), and refers to a device equipped with at least one of these functions.

According to an embodiment of the disclosure, an air conditioner may include a heat pump device for performing a cooling function or a heating function. The heat pump device may include a compressor, a first heat exchanger, an expansion device, and a refrigeration cycle in which a refrigerant is circulated through a second heat exchanger. According to one or more embodiments, components of the heat pump device may be built into a single housing that forms the exterior of the air conditioner, and window-type air conditioners or mobile air conditioners are examples of such air conditioners. According to one or more embodiments, some components of the heat pump device may be divided and built into a plurality of housings constituting one air conditioner, and wall-mounted air conditioners, stand-type air conditioners, system air conditioners, and the like are examples of such air conditioners.

An air conditioner including a plurality of housings may include at least one outdoor unit installed outside (e.g., in un-air-conditioned space), and at least one indoor unit installed in an indoor space. For example, the air conditioner may be provided such that one outdoor unit is connected to one indoor unit through a refrigerant pipe. For example, the air conditioner may be provided such that one outdoor unit is connected to two or more indoor units through refrigerant pipes. For example, the air conditioner may be provided such that two or more outdoor units are connected to two or more indoor units through a plurality of refrigerant pipes.

The outdoor unit may be electrically connected to the indoor unit. For example, information (or a command) for controlling the air conditioner may be input through an input interface provided on the outdoor unit or the indoor unit, and the outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger to the indoor heat exchanger.

The outdoor heat exchanger may perform heat exchange between a refrigerant and outdoor air by using a phase change (e.g., evaporation or condensation) of the refrigerant. For example, while the refrigerant is condensed in the outdoor heat exchanger, the refrigerant may release heat to the outdoor air, and while the refrigerant flowing in the outdoor heat exchanger evaporates, the refrigerant may absorb heat from the outdoor air.

The indoor unit is installed in an indoor space. For example, indoor units may be classified into ceiling-type indoor units, stand-type indoor units, wall-mounted indoor units, and the like, depending on the arrangement method thereof. For example, ceiling-type indoor units may be classified into 4-way indoor units, 1-way indoor units, and duct-type indoor units, and the like, depending on the air discharge method thereof.

Similarly, the indoor heat exchanger may perform heat exchange between a refrigerant and indoor air by using a phase change (e.g., evaporation or condensation) of the refrigerant. For example, the refrigerant may absorb heat from the indoor air while evaporating in the indoor unit, and the indoor space may be cooled by blowing the indoor air that has been cooled while passing through the cooled indoor heat exchanger. In addition, the refrigerant may release heat into the indoor air while being condensed in the indoor heat exchanger, and the indoor space may be heated by blowing the indoor air that has been heated while passing through the heated indoor heat exchanger.

In other words, the air conditioner performs a cooling or heating function through a phase change process of the refrigerant circulating between the outdoor heat exchanger and the indoor heat exchanger, and for such circulation of the refrigerant, the air conditioner may include a compressor configured to compress the refrigerant. The compressor may suck in refrigerant gas through a suction unit and compress the refrigerant gas. The compressor may discharge the high-temperature, high-pressure refrigerant gas through a discharge unit. The compressor may be arranged inside the outdoor unit.

The refrigerant may circulate through the refrigerant pipe to sequentially pass through the compressor, the outdoor heat exchanger, the expansion device, and the indoor heat exchanger, or may circulate through the refrigerant pipe to sequentially pass through the compressor, the indoor heat exchanger, the expansion device, and the outdoor heat exchanger.

For example, in a case in which the air conditioner has one outdoor unit and one indoor unit directly connected to each other through a refrigerant pipe, the refrigerant may be provided to circulate between one outdoor unit and one indoor unit through the refrigerant pipe.

For example, in a case in which the air conditioner has one outdoor unit connected to two or more indoor units through a refrigerant pipe, the refrigerant may flow to a plurality of indoor units through the refrigerant pipe branching from the outdoor unit. Refrigerants discharged from a plurality of indoor units may join together and then circulate to the outdoor unit. For example, a plurality of indoor units may be connected directly to one outdoor unit in parallel through separate refrigerant pipes.

Each of the plurality of indoor units may operate independently according to an operation mode set by a user. That is, some of the plurality of indoor units may operate in a cooling mode and others may operate in a heating mode at the same time. Here, the refrigerant may be selectively introduced into the respective indoor units at high or low pressure along circulation paths designated through a flow path switching valve, which will be described below, and then discharged to circulate to the outdoor unit.

For example, in a case in which the air conditioner has two or more outdoor units connected to two or more indoor units through a plurality of refrigerant pipes, refrigerants discharged from a plurality of outdoor units join together, then flow through one refrigerant pipe, and then branch out again at some point to be introduced into a plurality of indoor units.

All of the plurality of outdoor units may operate or at least some of them may not operate, depending on the operation load according to the operation amount of the plurality of indoor units. Here, the refrigerant may be provided to flow into and circulate in the outdoor unit that is selectively operating through a flow path switching valve. The air conditioner may include an expansion device for lowering the pressure of the refrigerant flowing into the heat exchanger. For example, the expansion device may be arranged inside the indoor unit or inside the outdoor unit, or may be arranged inside both.

For example, the expansion device may lower the temperature and pressure of the refrigerant by using a throttling effect. The expansion device may include an orifice that may reduce the cross-sectional area of a flow path. The temperature and pressure of the refrigerant that has passed through the orifice may be lowered.

For example, the expansion device may be implemented as an electronic expansion valve capable of adjusting an opening ratio (e.g., the ratio of the cross-sectional area of the flow path of the valve in a partially opened state to the cross-sectional area of the flow path of the value in a fully opened state). Depending on the opening ratio of the electronic expansion valve, the amount of refrigerant passing through the expansion device may be controlled.

The air conditioner may further include a flow path switching valve arranged on a refrigerant circulation flow path. The flow path switching valve may include, for example, a 4-way valve. The flow path switching valve may determine a circulation path of the refrigerant depending on the operation mode of the indoor unit (e.g., a cooling operation or a heating operation). The flow path switching valve may be connected to the discharge unit of the compressor.

The air conditioner may include an accumulator. The accumulator may be connected to the suction unit of the compressor. A low-temperature, low-pressure refrigerant evaporated in the indoor heat exchanger or the outdoor heat exchanger may flow into the accumulator.

When a mixture of refrigerant liquid and refrigerant gas flows into the accumulator, the accumulator may separate the refrigerant liquid from the refrigerant gas, and provide the compressor with the refrigerant gas from which the refrigerant liquid has been separated.

An outdoor fan may be provided adjacent to the outdoor heat exchanger. The outdoor fan may blow outdoor air to the outdoor heat exchanger to promote heat exchange between the refrigerant and the outdoor air.

The outdoor unit of the air conditioner may include at least one sensor. For example, the sensor of the outdoor unit may be provided as an environmental sensor. The outdoor unit sensor may be arranged at an arbitrary location inside or outside the outdoor unit. For example, the outdoor unit sensor may include, for example, a temperature sensor for detecting the temperature of air around the outdoor unit, a humidity sensor for detecting the humidity of air around the outdoor unit, a refrigerant temperature sensor for detecting the temperature of the refrigerant passing through the outdoor unit, or a refrigerant pressure sensor for detecting the pressure of the refrigerant in the refrigerant pipe passing through the outdoor unit, or combinations thereof.

The outdoor unit of the air conditioner may include an outdoor unit communication unit. The outdoor unit communication unit may be provided to receive a control signal from a control unit of the indoor unit of the air conditioner, which will be described below. The outdoor unit may control the operation of the compressor, the outdoor heat exchanger, the expansion device, the flow path switching valve, the accumulator, or the outdoor fan, or combinations thereof, based on a control signal received through the outdoor unit communication unit. The outdoor unit may transmit a sensing value detected by the outdoor unit sensor, to the control unit of the indoor unit through the outdoor unit communication unit.

The indoor unit of the air conditioner may include a housing, a blower that circulates air inside or outside the housing, and an indoor heat exchanger that exchanges heat with air flowing into the housing.

The housing may include a suction port. Indoor air may flow into the housing through the suction port.

The indoor unit of the air conditioner may include a filter provided to filter out foreign substances in air flowing into the housing through the suction port.

The housing may include a discharge port. Air flowing inside the housing may be discharged to the outside of the housing through the discharge port.

The housing of the indoor unit may be provided with an air current guide that guides through the direction of air discharged through the discharge port. For example, the air current guide may include a blade arranged on the discharge port. For example, the air current guide may include an auxiliary fan for controlling a discharged air current. The disclosure is not limited thereto, and the air current guide may be omitted.

An indoor heat exchanger and a blower arranged on a flow path connecting the suction port to the discharge port may be provided inside the housing of the indoor unit.

The blower may include an indoor fan and a fan motor. For example, the indoor fan may include an axial fan, a mixed flow fan, a cross-flow fan, and a centrifugal fan.

The indoor heat exchanger may be arranged between the blower and the discharge port, or between the suction port and the blower. The indoor heat exchanger may absorb heat from air introduced through the suction port, or transfer heat to air introduced through the suction port. The indoor heat exchanger may include a heat exchange tube through which the refrigerant flows, and a heat exchange fin in contact with the heat exchange tube to increase the heat transfer area.

The indoor unit of the air conditioner may include a drain tray arranged below the indoor heat exchanger to collect condensate generated from the indoor heat exchanger. The condensate accommodated in the drain tray may be drained to the outside through a drain hose. The drain tray may be provided to support the indoor heat exchanger.

The indoor unit of the air conditioner may include an input interface. The input interface may include any type of user input units, including buttons, switches, touch screens, and/or touch pads. The user may directly input setting data (e.g., a desired indoor temperature, operation mode settings for cooling/heating/dehumidification/air purification, an outlet selection setting, and/or an airflow volume setting) through the input interface.

The input interface may be connected to an external input device. For example, the input interface may be electrically connected to a wired remote controller. The wired remote controller may be installed at a particular location in an indoor space (e.g., a portion of a wall). The user may input setting data regarding the operation of the air conditioner by manipulating the wired remote controller. An electrical signal corresponding to the setting data obtained through the wired remote controller may be transmitted to the input interface. In addition, the input interface may include an infrared sensor. The user may remotely input setting data regarding the operation of the air conditioner by using a wireless remote controller. The setting data input through the wireless remote controller may be transmitted to the input interface as an infrared signal.

In addition, the input interface may include a microphone. A voice command of the user may be obtained through the microphone. The microphone may convert the voice command of the user into an electrical signal and transmit the electrical signal to an indoor unit control unit. The indoor unit control unit may control the components of the air conditioner to execute a function corresponding to the voice command of the user. The setting data (e.g., a desired indoor temperature, operation mode settings for cooling/heating/dehumidification/air purification, an outlet selection setting, and/or an airflow volume setting) obtained through the input interface may be delivered to the indoor unit control unit, which will be described below. In an example, setting data obtained through the input interface may be transmitted to the outside, that is, the outdoor unit or a server, through an indoor unit communication unit, which will be described below.

The indoor unit of the air conditioner may include a power module. The power module may be connected to an external power source to supply power to the components of the indoor unit.

The indoor unit of the air conditioner may include an indoor unit sensor. The indoor unit sensor may be an environmental sensor arranged inside or outside the housing. For example, the indoor unit sensor may include one or more temperature sensors and/or humidity sensors arranged in a defined space inside or outside the housing of the indoor unit. For example, the indoor unit sensor may include a refrigerant temperature sensor for detecting the temperature of a refrigerant in the refrigerant pipe passing through the indoor unit. For example, the indoor unit sensor may include refrigerant temperature sensors that detect the temperature of an inlet, a middle point, and/or an outlet of the refrigerant pipe passing through the indoor heat exchanger.

For example, environmental information detected by the indoor unit sensor may be delivered to the indoor unit control unit, which will be described below, or may be transmitted to the outside through the indoor unit communication unit, which will be described below.

The indoor unit of the air conditioner may include an indoor unit communication unit. The indoor unit communication unit may include at least one of a short-range wireless communication module or a long-range communication module. The indoor unit communication unit may include at least one antenna for wireless communication with other devices. The outdoor unit may include an outdoor unit communication unit. The outdoor unit communication unit may include at least one of a short-range wireless communication module or a long-range communication module.

The short-range wireless communication module may include, but is not limited to, a Bluetooth communication module, a Bluetooth Low Energy (BLE) communication module, a near-field communication (NFC) module, a wireless local area network (WLAN) (Wi-Fi) communication module, a Zigbee communication module, an Infrared Data Association (IrDA) communication module, a Wi-Fi Direct (WFD) communication module, an ultra-wideband (UWB) communication module, an Ant+ communication module, a microwave (uWave) communication module, and the like.

The long-range communication module may include a communication module for performing various types of long-range communication, and may include a mobile communication unit. The mobile communication unit transmits and receives radio signals to and from at least one of a base station, an external terminal, or a server, on a mobile communication network.

The indoor unit communication unit may communicate with external devices such as servers, mobile devices, or other home appliances, through a nearby access point (AP). The AP may connect a local area network (LAN) to which the air conditioner or a user device is connected, to a wide area network (WAN) to which a server is connected. The air conditioner or the user device may be connected to the server through the WAN. The indoor unit of the air conditioner may include an indoor unit control unit configured to control the components of the indoor unit, including the blower. The outdoor unit of the air conditioner may include an outdoor unit control unit configured to control the components of the outdoor unit, including the compressor. The indoor unit control unit may communicate with the outdoor unit control unit through the indoor unit communication unit and the outdoor unit communication unit. The outdoor unit communication unit may transmit, to the indoor unit communication unit, a control signal generated by the outdoor unit control unit, or may deliver, to the outdoor unit control unit, a control signal transmitted from the indoor unit communication unit. That is, the outdoor unit and the indoor unit may perform bidirectional communication. The outdoor unit and the indoor unit may transmit and receive various signals generated during the operation of the air conditioner.

The outdoor unit control unit may be electrically connected to the components of the outdoor unit, and may control the operation of each component. For example, the outdoor unit control unit may adjust the frequency of the compressor, and may control the flow path switching valve to change the circulation direction of the refrigerant. The outdoor unit control unit may adjust the rotational speed of an outdoor fan. In addition, the outdoor unit control unit may generate a control signal for adjusting the opening degree of the expansion valve. Under control of the outdoor unit control unit, the refrigerant may circulate along a refrigerant circulation circuit including the compressor, the flow path switching valve, the outdoor heat exchanger, the expansion valve, and the indoor heat exchanger.

Various temperature sensors included in the outdoor unit and the indoor unit may transmit electrical signals corresponding to respective detected temperatures to the outdoor unit control unit and/or the indoor unit control unit. For example, the humidity sensors included in the outdoor unit and the indoor unit may transmit electrical signals corresponding to respective detected humidities to the outdoor unit control unit and/or the indoor unit control unit.

The indoor unit control unit may obtain a user input from a user device, including a mobile device, through the indoor unit communication unit, and may obtain a user input directly through the input interface or through a remote controller. The indoor unit control unit may control the components of the indoor unit, including the blower, in response to the received user input. The indoor unit control unit may transmit information about the received user input to the outdoor unit control unit of the outdoor unit.

The outdoor unit control unit may control the components of the outdoor unit, including the compressor, based on the information about the user input received from the indoor unit. For example, when the outdoor unit control unit receives, from the indoor unit, a control signal corresponding to a user input for selecting an operation mode such as a cooling operation, a heating operation, a blowing operation, a defrosting operation, or a dehumidification operation, the outdoor unit control unit may control the components of the outdoor unit such that an operation of the air conditioner corresponding to the selected operation mode is performed.

The outdoor unit control unit and the indoor unit control unit may each include a processor and memory. The indoor unit control unit may include at least one first processor and at least one first memory, and the outdoor unit control unit may include at least one second processor and at least one second memory.

The memory may store various pieces of information necessary for the operation of the air conditioner. The memory may store instructions, applications, data, and/or programs necessary for the operation of the air conditioner. For example, the memory may store various programs for a cooling operation, a heating operation, a dehumidification operation, and/or a defrosting operation of the air conditioner. The memory may include a volatile memory such as static random-access memory (S-RAM) and dynamic RAM (D-RAM) for temporarily storing data. In addition, the memory may include a non-volatile memory such as read-only memory (ROM), erasable programmable ROM (EPROM), and electrically erasable programmable ROM (EEPROM) for long-term storage of data.

The processor may generate a control signal for controlling the operation of the air conditioner based on instructions, applications, data, and/or programs stored in the memory. The processor is hardware and may include logic circuits and arithmetic circuits. The processor may process data according to programs and/or instructions provided from the memory, and generate a control signal according to a result of the processing. The memory and the processor may be implemented as one control circuit or as a plurality of circuits.

The indoor unit of the air conditioner may include an output interface. The output interface may be electrically connected to the indoor unit control unit, and may output information related to the operation of the air conditioner under control of the indoor unit control unit. For example, information such as an operation mode, an airflow direction, an airflow volume, and a temperature selected by a user input may be output. In addition, the output interface may output sensing information obtained from the indoor unit sensor or the outdoor unit sensor, and warning/error messages.

The output interface may include a display and a speaker. The speaker is an audio device capable of outputting various sounds. The display may display information input by the user or information provided to the user, by using various graphic elements. For example, operation information of the air conditioner may be displayed as at least one of an image or a text. In addition, the display may include an indicator that provides particular information. The display may include a liquid-crystal display (LCD) panel, a light-emitting diode (LED) panel, an organic light-emitting diode (OLED) panel, a micro LED panel, and/or a plurality of LEDs.

Hereinafter, an air conditioner according to various embodiments will be described in detail with reference to the drawings.

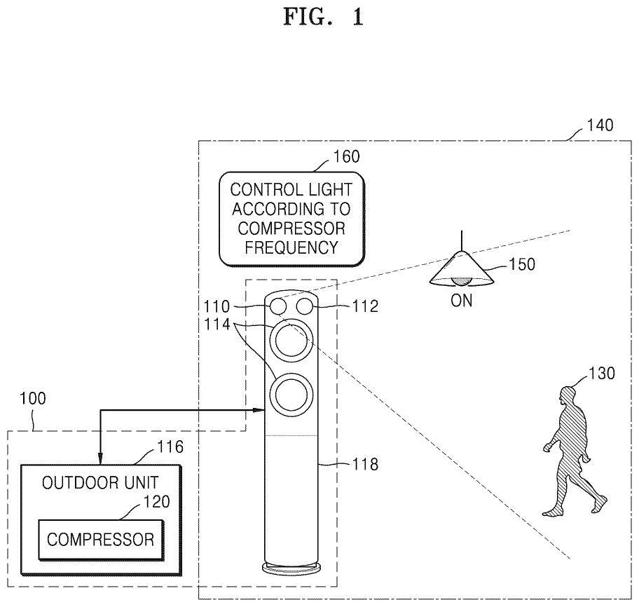

FIG. 1 is a diagram illustrating an operation of an air conditioner according to an embodiment of the disclosure.

According to an embodiment of the disclosure, an air conditioner 100 performs an air conditioning operation on a target space 140. The air conditioning operation may include, for example, cooling, heating, air purification, dehumidification, or blowing. The air conditioner 100 may be implemented in the form of a cooling device, a heat device, a cooling/heating device, an air purifier, a dehumidifier, or the like. In the disclosure, descriptions will focus on a case in which the air conditioner 100 corresponds to a cooling device. However, this is for convenience of description, and an embodiment of the disclosure is not limited thereto.

The air conditioner 100 may include an indoor unit 118 and an outdoor unit 116. The indoor unit 118 is arranged inside the target space 140 and discharges cooled air into the target space 140. The indoor unit 118 may be provided in various forms such as a stand type, an embedded type, or a window installation type. The outdoor unit 116 is arranged outside the target space 140. The outdoor unit 116 cools a refrigerant through a compressor 120 and supplies the cooled refrigerant to the indoor unit 118. The refrigerant that has absorbed heat in the indoor unit 118 is supplied back to the outdoor unit 116. The indoor unit 118 and the outdoor unit 116 are connected to each other by a hose 119, and heat exchange is performed as the refrigerant circulates through the hose 119.

The compressor 120 of the outdoor unit 116 absorbs heat from the refrigerant while rotating at a certain frequency according to a set temperature. The compressor frequency changes depending on a set temperature of the air conditioner 100. Here, the power consumption of the outdoor unit 116 varies depending on the frequency of the compressor. As the compressor frequency of the outdoor unit 116 increases, the power consumption of the air conditioner 100 increases. The compressor 120 of the outdoor unit 116 often occupies the highest proportion of the power consumption of the air conditioner 100.

The air conditioner 100 may include a detection sensor 110. The detection sensor 110 detects an object inside the target space 140. The air conditioner 100 may detect a motion value of a user 130 inside the target space 140 by using a sensor detection value of the detection sensor 110. In the disclosure, the user 130 may correspond to a person or a pet in the target space 140.

In addition, the air conditioner 100 may include an illuminance sensor 112. The illuminance sensor 112 detects the illuminance of the target space 140. The air conditioner 100 may identify or obtain an illuminance value for the target space 140 by using a sensor detection value of the illuminance sensor 112. The illuminance value may vary depending on whether an indoor lighting device 150 is turned on/off, a set luminous intensity of the indoor lighting device 150, lightness, whether other sources of light, such as windows or lamps, are present within the target space 140, and the like in the target space 140.

In addition, the air conditioner 100 may include a light 114. According to one or more embodiments, the air conditioner 100 may include multiple instances of the light 114 at various locations in a housing of the air conditioner 100. For example, the light 114 may be provided in a location around an air discharge port of the air conditioner 100, a certain locations on the surface of the housing, and the like. In addition, the light 114 may be provided in various forms such as a line light, a plane light, or a circular lamp.

The target space 140 refers to an indoor space where the air conditioner 100 may be installed. The target space 140 may correspond to various types of indoor spaces, such as houses, offices, stores, guest rooms, commercial spaces, or work spaces.

The air conditioner 100 determines whether a detected illuminance value is greater than or equal to an illuminance reference value, by using the illuminance sensor 112. According to an embodiment of the disclosure, the air conditioner 100 may control an operation mode of the light 114 according to an illuminance value. According to an embodiment of the disclosure, the air conditioner 100 may increase the usability of the light 114 of the air conditioner 100 by controlling the operation mode of the light 114 differently during daytime and nighttime, and increase user convenience by operating according to the needs of the user 130.

In addition, the air conditioner 100 determines whether the user 130 is in the target space 140, by using the detection sensor 110. According to an embodiment of the disclosure, the air conditioner 100 may control the operation mode of the light 114 differently depending on whether the user 130 is in the target space 140.

In operation 160, when an illuminance value detected by the illuminance sensor 112 is greater than or equal to the illuminance reference value, and the user 130 is detected in the target space 140, the air conditioner 100 may control the light 114 in a first mode in which at least one of the luminous intensity or a luminous intensity change pattern of the light 114 is controlled based on the compressor frequency of the air conditioner 100. When the illuminance value is greater than the illuminance reference value and the user 130 is present in the target space 140, the air conditioner 100 may provide information about the power consumption through the light 114. According to an embodiment of the disclosure, the air conditioner 100 may provide information or a notification about the power consumption through the light 114, by controlling the light 114 based on the compressor frequency of the compressor 120 of the outdoor unit 116, which accounts for the highest proportion of the power consumption.

A significant portion of the power consumption of the air conditioner 100 is consumed by the compressor 120 of the outdoor unit 116. For example, in a case in which the outdoor unit 116 includes an inverter compressor, approximately 90% or greater of the power consumption is consumed by the compressor 120. The operating frequency of the compressor 120, that is, the compressor frequency, is usually determined by the difference between the indoor temperature and the set temperature. The compressor 120 operates at a high frequency (Hz) when the difference between the indoor temperature and the set temperature is relatively large, and operates at a low frequency (Hz) when the difference between the indoor temperature and the set temperature is relatively small. As the compressor frequency of the compressor 120 increases, the power consumption of the air conditioner 100 increases. However, because the compressor 120 is arranged in the outdoor unit 116, the user 130 of the target space 140, which is an indoor space, may not know the operation status of the compressor 120. In addition, even when the compressor 120 continuously operates or drives at a high frequency due to a window opened or other abnormal situation, the user 130 may not know the abnormal status of the air conditioner 100. According to an embodiment of the disclosure, when the illuminance of the target space 140 is greater than or equal to a predetermined illuminance reference value and the user 130 is present in the target space 140, information about the power consumption and information about the operation status of the outdoor unit 116 may be effectively provided to the user 130 by providing information about the compressor frequency of the compressor 120 by using the light 114.

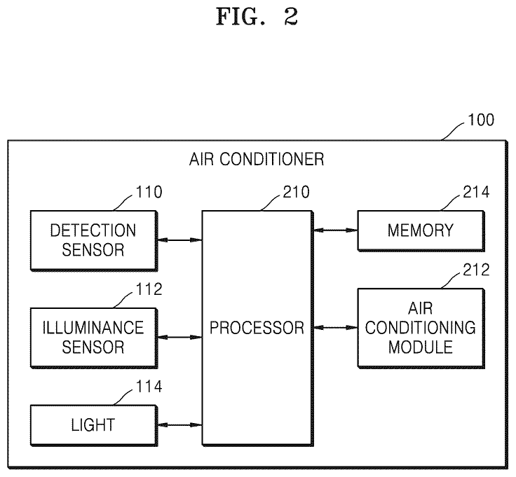

FIG. 2 is a diagram illustrating a structure of an air conditioner according to an embodiment of the disclosure.

According to an embodiment of the disclosure, the air conditioner 100 includes the detection sensor 110, the illuminance sensor 112, the light 114, a processor 210, an air conditioning module 212, and memory 214. The block diagram of the air conditioner 100 of FIG. 2 may correspond to a block diagram of an indoor unit. According to an embodiment of the disclosure, the air conditioner 100 may further include the outdoor unit 116 and the compressor 120.

The air conditioner 100 may be implemented in various installation forms. For example, the air conditioner 100 may be implemented in the form of a stand-type air conditioner, a wall-mounted air conditioner, a ceiling-embedded system air conditioner, or a home multi-air conditioner.

The detection sensor 110 may detect an object in the target space 140. The detection sensor 110 may include, for example, a time-of-flight (ToF) sensor, an ultrasonic sensor, an infrared sensor, an optical sensor, a camera, a radio detection and ranging (RADAR) sensor, a light detection and ranging (LiDAR) sensor, or the like. The detection sensor 110 is arranged to output a signal to the target space 140 and detect a reflected signal. The detection sensor 110 may be arranged in front of the air conditioner 100 toward the target space 140. The detection sensor 110 generates a sensor detection value and transmits it to the processor 210.

The illuminance sensor 112 is a sensor configured to measure the brightness of the target space 140. The illuminance sensor 112 may include, for example, a photoresistor, a photodiode, a phototransistor, or the like. The illuminance sensor 112 may be arranged in front of the air conditioner 100 toward the target space 140 to detect the illuminance of the target space 140. The illuminance sensor 112 may generate an illuminance value and transmit it to the processor 210.

The light 114 is a device configured to output light toward the target space 140. The light 114 may be embedded in or coupled to the housing of the air conditioner 100 to radiate or emit light around the air conditioner 100. The light 114 may include, for example, an LED light. The light 114 may be arranged in various shapes such as a line shape, a plane shape, or a point shape. The light 114 may include a plurality of LED lights. The processor 210 may control the turning on/off, luminous intensity, or timing of each of the plurality of LED lights. The light 114 may perform operations such as turning on/off, luminous intensity change, dimming, or color change.

The processor 210 controls the overall operation of the air conditioner 100. The processor 210 may be implemented as one or more processors. The processor 210 may execute instructions or commands stored in the memory 214 to perform a certain operation. In addition, the processor 210 controls the operation of components provided in the air conditioner 100. The processor 210 may include a central processing unit (CPU), a microprocessor, and the like.

The processor 210 determines whether a moving object is present, by using a sensor detection value of the detection sensor 110, and when a moving object is present, determines that a human is present in the target space 140. According to an embodiment of the disclosure, the processor 210 determines whether the detected object is a human, by using the sensor detection value. For example, in a case in which the detection sensor 110 corresponds to an infrared sensor, when an infrared value corresponding to a human is detected, the processor 210 determines that a human is present in the target space 140. According to an embodiment of the disclosure, the processor 210 determines whether the detected object is in the shape of a human, based on the sensor detection value, and when the detected object corresponds to the shape of a human, determines that a human, that is, the user 130, is present in the target space 140.

When there is no moving object in the target space 140, the processor 210 may determine that no human is present in the target space 140, by using a sensor detection value of the detection sensor 110.

According to an embodiment of the disclosure, the detection sensor 110 may correspond to a RADAR sensor, and the processor 210 may determine whether the detected object is in the shape of a human, by using a sensor detection value of the RADAR sensor. The RADAR sensor outputs a RADAR signal to the target space 140 and detects, as a sensor detection value, the signal reflected from the object in the target space 140. The processor 210 detects the object in the target space 140 by using the sensor detection value of the RADAR sensor. The processor 210 detects an object in the target space 140 at a predetermined frame rate, and detects a motion of the object. When a motion value of the object in the target space 140 is greater than or equal to a reference value, the processor 210 determines that a human is present in the target space 140. For example, the processor 210 detects an object in the target space 140 at a rate of substantially 30 frames/see, and when a motion value per second of the object is greater than a reference value, determines that a human is present in the target space 140.

In addition, according to an embodiment of the disclosure, based on a result of recognizing an object based on a sensor detection value of the RADAR sensor, the processor 210 determines whether the recognized object is a human. The processor 210 may determine whether the recognized object is a human, based on the shape of the recognized object. When the recognized object corresponds to a human and the motion value is greater than or equal to a reference value, the processor 210 determines that a human is present in the target space 140. When it is determined that the recognized object does not correspond to a human, the processor 210 determines that no human is present in the target space 140. In addition, according to an embodiment of the disclosure, even when the recognized object corresponds to a pet, the processor 210 may determine that no human is present in the target space 140. Thus, when the detected object corresponds to a human or a pet and the motion value is greater than or equal to the reference value, the processor 210 may determine that a human is present in the target space 140.

The air conditioning module 212 performs an air conditioning operation. The air conditioning module 212 adjusts whether to perform cooling, cooling intensity, whether to perform heating, heating intensity, an airflow volume, and the like, based on a control signal or a driving signal input from the processor 210. The air conditioning module 212 may include a heat exchanger, a motor, an inverter, a fan, a filter, and the like. The air conditioning module 212 may include a heat exchanger and may perform heat exchange between a refrigerant of the heat exchanger and indoor air by using a phase change (e.g., expansion or compression) of the refrigerant. For example, while the refrigerant expands in the heat exchanger, the refrigerant may absorb heat from the indoor air, and the indoor space may be cooled. While the refrigerant is compressed in the heat exchanger, the refrigerant may release heat into the indoor air, and the indoor space may be heated.

In addition, the air conditioning module 212 may include the outdoor unit 116, and the outdoor unit 116 may include the compressor 120. The processor 210 may set the compressor frequency of the compressor 120 of the outdoor unit 116 according to the difference between the indoor temperature and the set temperature. In addition, the processor 210 may monitor the state of the outdoor unit 116 and the compressor 120.

The memory 214 stores various pieces of information, data, instructions, programs, and the like necessary for the operation of the air conditioner 100. The memory 214 may include at least one of a volatile memory or a non-volatile memory, or a combination thereof. The memory 214 may include at least one of a flash memory-type storage medium, a hard disk-type storage medium, a multimedia card micro-type storage medium, a card-type memory (e.g., Secure Digital (SD) or extreme Digital (XD) memory), random-access memory (RAM), static RAM (SRAM), read-only memory (ROM), electrically erasable programmable ROM (EEPROM), programmable ROM (PROM), magnetic memory, a magnetic disk, or an optical disc. In addition, the memory 214 may correspond to a web storage or a cloud server that performs a storage function on the Internet.

The processor 210 obtains an illuminance value from the illuminance sensor 112. According to an embodiment of the disclosure, the processor 210 may obtain an illuminance value by performing a predetermined process on the sensor detection value from the illuminance sensor 112. The processor 210 determines whether the illuminance value is greater than or equal to a first illuminance reference value. The first illuminance reference value may be, for example, substantially 6 lux.

In addition, when the illuminance value is greater than or equal to the first illuminance reference value, and the user 130 is present in the target space 140, the processor 210 controls the luminous intensity or a luminous intensity change pattern of the light 114 based on the compressor frequency of the air conditioning module 212. The luminous intensity refers to the brightness or intensity of the light 114. The processor 210 may control the luminous intensity of the light 114 through a control signal for controlling the brightness of the light 114. The luminous intensity change pattern refers to a pattern in which the luminous intensity of the light 114 changes. A change in the luminous intensity may be defined by a combination of an increasing pattern, a decreasing pattern, or a maintaining pattern of the luminous intensity. The luminous intensity change pattern may have a certain period. For example, the luminous intensity change pattern may be defined in the form of a sine (sin) function or a cosine (cos) function. The luminous intensity change pattern may be defined by a maximum luminous intensity, a minimum luminous intensity, and a period. For example, the luminous intensity change pattern may have the form of a sine (sin) function, and may be defined by a maximum illuminance, a minimum illuminance, and a period.

In addition, for example, the luminous intensity change pattern may include a color change pattern of the light 114.

According to an embodiment of the disclosure, the processor 210 may define the illuminance value of the light 114, that is, light intensity, based on the compressor frequency. For example, the processor 210 may increase the light intensity of the light 114 as the compressor frequency increases.

In addition, according to an embodiment of the disclosure, the processor 210 may define parameters of the luminous intensity change pattern based on the compressor frequency. The parameters of the luminous intensity change pattern may include at least one of a period, a maximum luminous intensity, or a minimum luminous intensity. For example, the processor 210 may adjust the period of the luminous intensity change pattern based on the compressor frequency. In detail, the processor 210 may decrease the period of the luminous intensity change pattern as the compressor frequency increases.

In addition, for example, the processor 210 may change the color of the light 114 based on the compressor frequency. The light 114 may include a plurality of lighting elements with different colors, and the lighting color may be adjusted by selectively turning on the plurality of lighting elements.

The luminous intensity change pattern may be defined by a period, a maximum luminous intensity, a minimum luminous intensity, or various combinations of lighting colors.

According to an embodiment of the disclosure, when the illuminance value is less than the first illuminance reference value or when the user 130 is not detected in the target space 140, the processor 210 may not operate in the first mode in which the light 114 is controlled according to the compressor frequency.

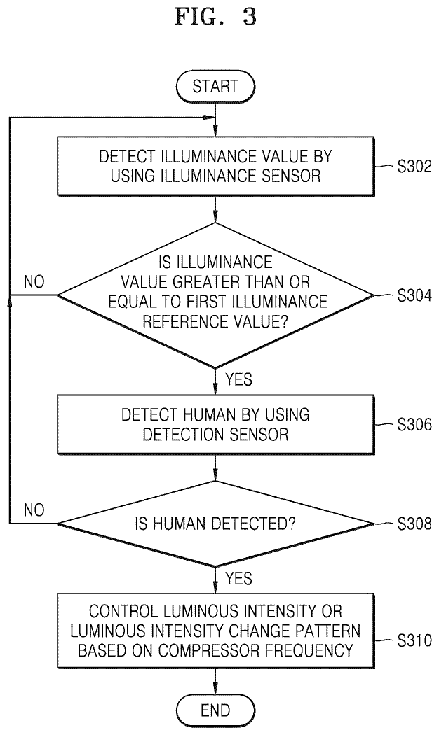

FIG. 3 is a flowchart of a method of controlling an air conditioner, according to an embodiment of the disclosure.

According to an embodiment of the disclosure, the method of controlling an air conditioner may be performed by the air conditioner 100. In the disclosure, descriptions will focus on an embodiment in which the air conditioner 100 performs the method of controlling an air conditioner.

Referring to FIG. 3, in operation S302, the air conditioner 100 detects an illuminance value by using the illuminance sensor 112. The air conditioner 100 may detect an illuminance value of the target space 140 by using the illuminance sensor 112.

Next, in operation S304, the air conditioner 100 determines whether the illuminance value detected by the illuminance sensor 112 is greater than or equal to a first illuminance reference value. For example, the first illuminance reference value may be determined within the range of about 4 lux to about 8 lux. For example, the first illuminance reference value may correspond to substantially 6 lux.

When the illuminance value detected by the illuminance sensor 112 is greater than or equal to the first illuminance reference value, in operation S306, the air conditioner 100 may detect a human, that is, the user 130, in the target space 140 by using the detection sensor 110. The air conditioner 100 may detect the user 130 in the target space 140 by using a sensor detection value of the detection sensor 110.

Next, in operation S308, the air conditioner 100 determines whether the user 130 has been detected in the target space 140.

When a human is detected, in operation S310, the air conditioner 100 controls the luminous intensity or a luminous intensity change pattern of the light 114 based on the compressor frequency of the outdoor unit 116. When the illuminance value of the target space 140 is greater than or equal to the first illuminance reference value and the user 130 is detected in the target space 140, the air conditioner 100 may control the air conditioning module 212 in a first mode. In the first mode, the air conditioner 100 controls the luminous intensity or the luminous intensity change pattern of the light 114 based on the compressor frequency of the outdoor unit 116.

According to an embodiment of the disclosure, the air conditioner 100 may define the illuminance value of the light 114, that is, light intensity, based on the compressor frequency. For example, the processor 210 may increase the illuminance of the light 114 as the compressor frequency increases. In addition, according to an embodiment of the disclosure, the air conditioner 100 may define parameters of the luminous intensity change pattern based on the compressor frequency. The parameters of the luminous intensity change pattern may include at least one of a period, a maximum luminous intensity, or a minimum luminous intensity. For example, the processor 210 may adjust the period of the luminous intensity change pattern based on the compressor frequency. In detail, the processor 210 may decrease the period of the luminous intensity change pattern as the compressor frequency increases.

According to an embodiment of the disclosure, in the first mode, the air conditioner 100 may provide information about the compressor frequency through the light 114 for a predetermined time period, and turn off the light 114 after the predetermined time period elapses. For example, in the first mode, the air conditioner 100 may control the luminous intensity or the luminous intensity change pattern of the light 114 according to the compressor frequency for substantially 30 seconds, and then turn off the light 114.

In addition, according to an embodiment of the disclosure, in the first mode, the air conditioner 100 may provide information about the compressor frequency through the light 114 for a predetermined time period at every predetermined period, and then turn off the light 114. For example, the air conditioner 100 may provide information about the compressor frequency through the light 114 every substantially 10 minutes. In addition, the air conditioner 100 may turn on the light 114 with a luminous intensity or a luminous intensity change pattern corresponding to the compressor frequency for a substantially 30-second section in a substantially 10-minute period, and turn off the light 114 in other time sections than the substantially 30-second section in the substantially 10-minute period.

In addition, according to an embodiment of the disclosure, in the first mode, when the compressor frequency changes by a predetermined range or greater, the air conditioner 100 may provide information about the compressor frequency through the light 114 for a predetermined time period. For example, in the first mode, when the compressor frequency increases by substantially 1.5 times or greater in substantially 30 seconds, the air conditioner 100 may provide information about the compressor frequency through the light 114 for substantially 30 seconds. In addition, for example, the air conditioner 100 may define a certain number of ranges for the compressor frequency, and when the compressor frequency changes to another range among the numbers of ranges, provide information about the compressor frequency through the light 114.

In addition, according to an embodiment of the disclosure, in the first mode, when the compressor frequency is greater than a reference value, the air conditioner 100 may provide information about the compressor frequency through the light 114. For example, when the compressor frequency is greater than a value corresponding to substantially 50% of the total range of the compressor frequency, the air conditioner 100 may provide information about the compressor frequency through the light 114.

According to an embodiment of the disclosure, the order of performing operations S302 and S306 is not limited to the order shown in FIG. 3, and operations S302 and S306 may be performed repeatedly during operation of the air conditioner 100. For example, operations S302 and S306 may be performed at all times or periodically while the air conditioner 100 is operating. In addition, according to an embodiment of the disclosure, operation S306 may be performed first and operation S302 may be performed later. In addition, according to an embodiment of the disclosure, operations S302 and S306 may be performed in parallel.

In addition, according to an embodiment of the disclosure, the order of performing operations S304 and S308 is not limited to the order shown in FIG. 3. According to an embodiment of the disclosure, operation S308 may be performed first and operation S304 may be performed later. In addition, according to an embodiment of the disclosure, operations S304 and S308 may be performed in parallel.

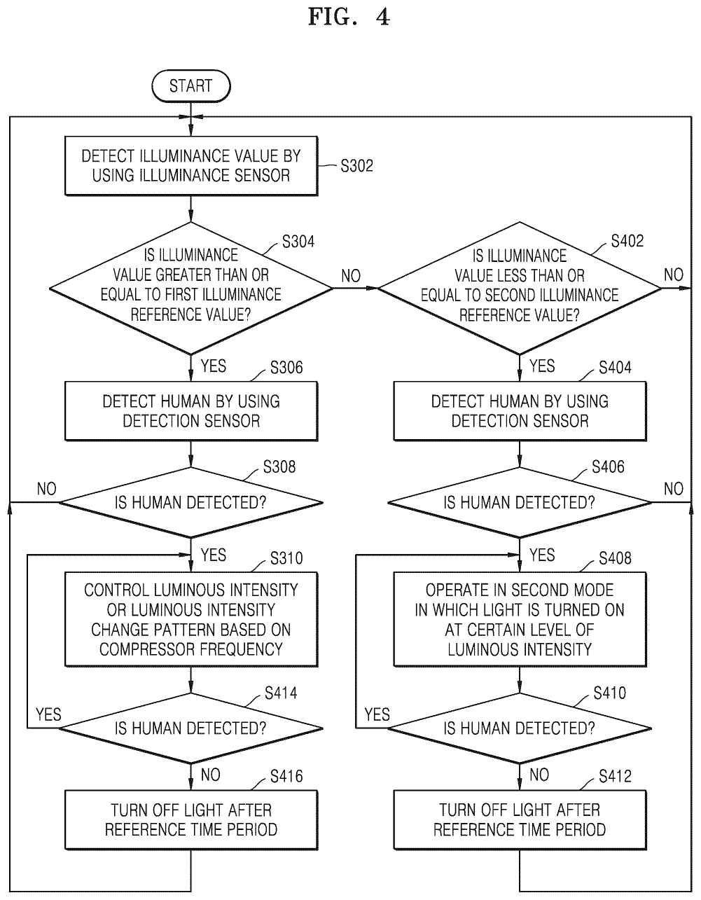

FIG. 4 is a flowchart of a method of controlling an air conditioner, according to an embodiment of the disclosure.

According to an embodiment of the disclosure, the air conditioner 100 may operate in a first mode in which the light 114 is controlled based on a compressor frequency, and in a second mode in which the light 114 is turned on at a certain level of luminous intensity. When the illuminance value is greater than or equal to a first illuminance reference value, the air conditioner 100 may determine that it is the time when the user 130 is active, and thus operate in the first mode in which, when the user 130 is detected, information about an operation of the compressor 120 of the outdoor unit 116 is provided through the light 114. In addition, when the illuminance value is greater than or equal to a second illuminance reference value, the air conditioner 100 may determine that it is nighttime, and thus operate in the second mode to, when the user 130 is detected, provide indoor lighting through the light 114 to assist an activity of the user 130.

In FIG. 4, in order to avoid duplication of description, redundant descriptions provided above with reference to FIG. 3 will be omitted, and the description will focus on the difference from FIG. 3.

Referring to FIG. 4, in operation S302, the air conditioner 100 detects an illuminance value of the target space 140 by using the illuminance sensor 112.

Next, in operation S304, the air conditioner 100 determines whether the illuminance value detected by the illuminance sensor 112 is greater than or equal to a first illuminance reference value. When, in operation S304, the illuminance value detected by the illuminance sensor 112 is greater than or equal to the first illuminance reference value, in operation S306, the air conditioner 100 detects a human in the target space 140, that is, the user 130, by using the detection sensor 110. When, in operation S308, the air conditioner 100 determines that the user 130 has been detected in the target space 140, in operation S310, the air conditioner 100 operates in a first mode in which at least one of the luminous intensity or a luminous intensity change pattern of the light 114 is controlled based on the compressor frequency of the outdoor unit 116.

Next, in operation S414, the air conditioner 100, while operating in the first mode, determines whether the user 130 has been detected in the target space 140. When the user 130 is not detected in the target space 140, in operation S416, the air conditioner 100 controls the light 114 in the first mode for a reference time period and then turns off the light 114.

When it is determined in operation S304 that the illuminance value detected by the illuminance sensor 112 is less than the first illuminance reference value, in operation S402, the air conditioner 100 determines whether the illuminance value detected by the illuminance sensor 112 is less than or equal to a second illuminance reference value. The second illuminance reference value is less than or equal to the first illuminance reference value, and greater than 0. For example, the second illuminance reference value may be determined within the range of 2 lux to 4 lux. For example, the second illuminance reference value may be set to 3 lux.

When, in operation S402, the illuminance value detected by the illuminance sensor 112 is less than or equal to the second illuminance reference value, in operation S404, the air conditioner 100 detects the user 130 in the target space 140 by using a sensor detection value of the detection sensor 110. In operation S406, the air conditioner 100 determines whether the user 130 has been detected in the target space 140.

When, in operation S408, the user 130 is detected in the target space 140, in operation S408, the air conditioner 100 operates in a second mode in which the light 114 of the air conditioner 100 is turned on at a first level of luminous intensity. The first level of level of luminous intensity may correspond to, for example, an illuminance within the range of substantially 10 lux to substantially 100 lux. The first level of luminous intensity may correspond to night lighting or sleep lighting for assisting the user 130 at night. The air conditioner 100 may provide night lighting to the user 130 by constantly controlling the luminous intensity of the light 114 at the first level of luminous intensity.

Next, in operation S410, in a state in which the light 114 is turned on in the second mode, the air conditioner 100 determines whether the user 130 has been detected in the target space 140. When the user 130 is detected in the target space 140 in the second mode, the air conditioner 100 proceeds to operation S408 to control the light 114 to continue operating in the second mode.

When the user 130 is not detected in the target space 140 in the second mode, in operation S412, the air conditioner 100 maintains the light 114 at the first level of luminous intensity for a reference time period, and then turns off the light 114.

The air conditioner 100 may repeatedly perform operations S302, S306, and S404, and may determine whether to operate in the first mode or the second mode. In addition, the order of operations S302, S306, and S404 is not limited to the order shown in FIG. 4, and the respective operations may be performed repeatedly, may be performed in an order different from that of FIG. 4, or may be performed in parallel.

In addition, according to an embodiment of the disclosure, the order of performing operations S304 and S308 is not limited to the order shown in FIG. 4. According to an embodiment of the disclosure, operation S308 may be performed first and operation S304 may be performed later. In addition, according to an embodiment of the disclosure, operations S304 and S308 may be performed in parallel.

In addition, according to an embodiment of the disclosure, the order of performing operations S402 and S406 is not limited to the order shown in FIG. 4. According to an embodiment of the disclosure, operation S406 may be performed first and operation S402 may be performed later. In addition, according to an embodiment of the disclosure, operations S402 and S406 may be performed in parallel.

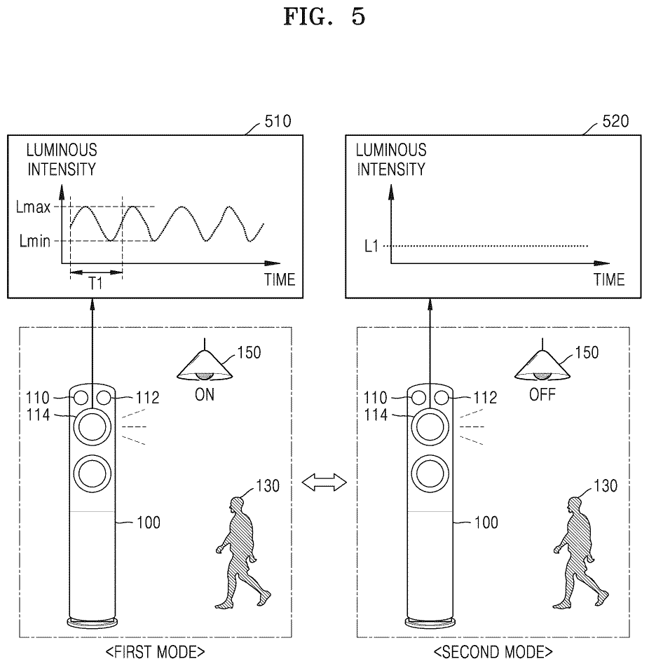

FIG. 5 is a diagram illustrating operations in a first mode and a second mode, according to an embodiment of the disclosure.

According to an embodiment of the disclosure, when the illuminance value detected by the illuminance sensor 112 is greater than or equal to the first illuminance reference value, and the user 130 is detected in the target space 140, the air conditioner 100 operates in the first mode. For example, when the indoor lighting device 150 of the target space 140 has been turned on or when natural light is incident on the target space 140 in a daytime, the illuminance value detected by the illuminance sensor 112 may be greater than or equal to the first illuminance reference value.

In addition, according to an embodiment of the disclosure, when the illuminance value detected by the illuminance sensor 112 is less than or equal to the second illuminance reference value, and the user 130 is detected in the target space 140, the air conditioner 100 operates in the second mode. For example, when the indoor lighting device 150 of the target space 140 has been turned off and natural light is not incident at a certain level of illuminance or greater, the illuminance value detected by the illuminance sensor 112 may be less than or equal to the second illuminance reference value.

In the first mode, the air conditioner 100 may adjust the luminous intensity or a luminous intensity change pattern of the light 114 based on the compressor frequency of the compressor 120. The luminous intensity change pattern may include at least one of a dimming pattern, a blinking pattern, a light direction change pattern, or a light width change pattern. The dimming pattern refers to a pattern in which the luminous intensity gradually decreases and the light gradually becomes brighter. The blinking pattern refers to a pattern in which the light 114 is repeatedly turned on and off. The light direction change pattern refers to a pattern in which the direction of the light 114 is changed over time. For example, in a case in which the light 114 includes a plurality of light-emitting elements, the air conditioner 100 may change the direction of the light 114 by changing a section in which the light-emitting elements are turned on over time. The light width change pattern refers to a pattern in which the width of a turn-on section of the light 114 is changed over time.

According to an embodiment of the disclosure, in the first mode, the air conditioner 100 may control the luminous intensity of the light 114 over time as in a pattern 510. For example, the pattern 510 corresponds to a pattern of a sine function, and may have a period of T1. In addition, pattern 510 may have a minimum level Lmin and a maximum level Lmax. According to an embodiment of the disclosure, the air conditioner 100 may adjust at least one of a period, a minimum level, or a maximum level of the luminous intensity change pattern based on the compressor frequency. For example, the air conditioner 100 may decrease the period T1 as the compressor frequency increases, and may increase the period T1 as the compressor frequency decreases. In addition, for example, the air conditioner 100 may increase at least one of the minimum level Lmin or the maximum level Lmax as the compressor frequency increases, and may decrease at least one of the minimum level Lmin or the maximum level Lmax as the compressor frequency decreases.

According to an embodiment of the disclosure, in the first mode, the air conditioner 100 may adjust the luminous intensity level of the light 114 based on an illuminance value detected by the illuminance sensor 112. The air conditioner 100 may increase the luminous intensity level of the light 114 as the illuminance value detected by the illuminance sensor 112 increases, and may decrease the luminous intensity level of the light 114 as the illuminance value detected by the illuminance sensor 112 decreases. For example, in the pattern 510, the air conditioner 100 may adjust at least one of the minimum level Lmin or the maximum level Lmax based on the illuminance value detected by the illuminance sensor 112. According to an embodiment of the disclosure, in the first mode, the visibility of information about the compressor frequency through the light 114 may be improved by adjusting at least one of the minimum level Lmin or the maximum level Lmax based on the illuminance value detected by the illuminance sensor 112.

According to an embodiment of the disclosure, in the second mode, the air conditioner 100 turns on the light 114 at the first level of luminous intensity. According to an embodiment of the disclosure, the first level may correspond to the minimum luminous intensity that may be set for the light 114. In the second mode, the air conditioner 100 maintains the luminous intensity of the light 114 to be constant at the first level. In the second mode, the light 114 may function as a night light or an interior light.

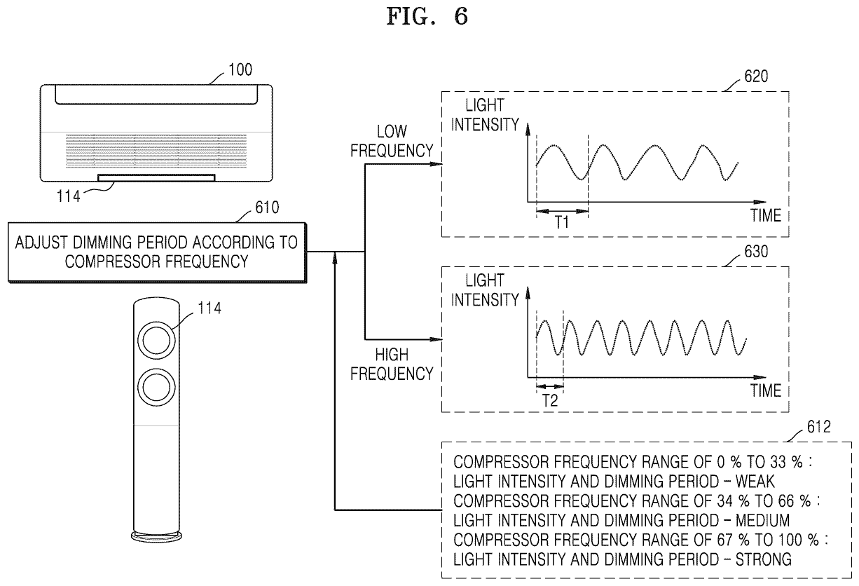

FIG. 6 is a diagram illustrating an operation of an air conditioner in a first mode, according to an embodiment of the disclosure.

According to an embodiment of the disclosure, in the first mode, the air conditioner 100 may control the luminous intensity of the light 114 for dimming in the form of a sine function. In operation 610, while operating in the first mode, the air conditioner 100 may adjust a dimming period according to the compressor frequency.

According to an embodiment of the disclosure, the air conditioner 100 may control the light 114 according to the compressor frequency according to a standard 612. According to the standard 612, the air conditioner 100 may divide the total range of compressor frequency into a certain number of ranges, and control the intensity and a dimming period of the light 114 according to the range to which the compressor frequency belongs. For example, the standard 612 may divide the range of compressor frequency into three sections, that is, substantially 0% to substantially 33%, substantially 34% to substantially 66%, and substantially 67% to substantially 100% of the total range. It should be appreciated that other ranges can be used, and that the example ranges described are not intended to be limiting. The standard 612 may define the light intensity and the dimming period as ‘weak’ for the compressor frequency section of substantially 0% to substantially 33%. In addition, the standard 612 may define the light intensity and the dimming period as ‘medium’ for the compressor frequency section of substantially 34% to substantially 66%. In addition, the standard 612 may define the light intensity and the dimming period as ‘strong’ for the compressor frequency section of substantially 67% to substantially 100%. For example, the light intensity of the ‘weak’ level, the light intensity of the ‘medium’ level, and the light intensity of the ‘strong’ level may each be defined as a certain luminous intensity value. The light intensity of the ‘medium’ level may be defined as a luminous intensity value greater than that of the ‘weak’ level, and the light intensity of the ‘strong’ level may be defined as a luminous intensity value greater than that of the ‘medium’ level. In addition, for example, the dimming period of the ‘weak’ level, the dimming period of the ‘medium’ level, and the dimming period of the ‘strong’ level may each be defined as a certain period value. The dimming period of the ‘medium’ level may be defined as a period value less than that of the ‘weak’ level, and the dimming period of the ‘strong’ level may be defined as a period value less than that of the ‘medium’ level.

Luminous intensity change patterns 620 and 630 for two compressor frequencies, that is, a low frequency and a high frequency, will be described as examples with reference to FIG. 6. When the compressor frequency corresponds to a relatively low frequency, the air conditioner 100 may control the intensity of the light 114, that is, the luminous intensity, by using the pattern 620. In the pattern 620, a period of change in luminous intensity corresponds to T1. In addition, when the compressor frequency corresponds to a relatively high frequency, the air conditioner 100 may control the luminous intensity of the light 114 by using the pattern 630. In the pattern 630, a period of change in luminous intensity corresponds to T2. T1 may be longer than T2. According to an embodiment of the disclosure, as illustrated in FIG. 6, information about the compressor frequency may be provided to the user 130 through the light 114 by adjusting the dimming period of the light 114 according to the compressor frequency.

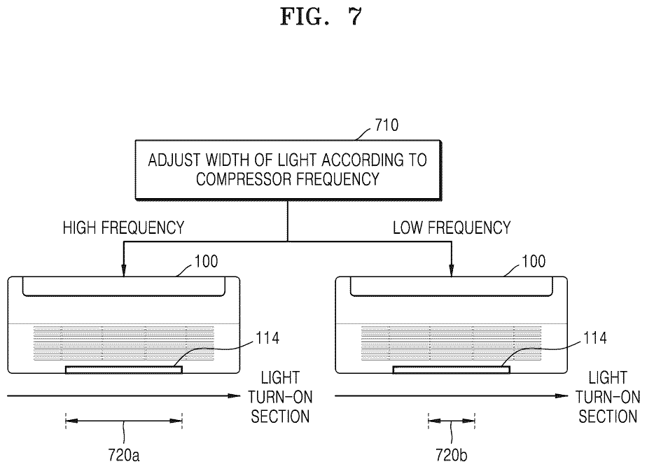

FIG. 7 is a diagram illustrating a process of controlling a light in a first mode, according to an embodiment of the disclosure.

According to an embodiment of the disclosure, in operation 710, while operating in the first mode, the air conditioner 100 may adjust the width of a turn-on section of the light 114 according to the compressor frequency. According to an embodiment of the disclosure, the light 114 may correspond to a line-shaped light, and may include a plurality of light-emitting elements. For example, light 114 may include a plurality of LED elements. The air conditioner 100 may adjust the width of the turn-on section of the light 114 by turning on some of the plurality of light-emitting elements. For example, in a case in which the light 114 includes a plurality of LED elements, the air conditioner 100 may adjust the width of the turn-on section of the light 114 by adjusting the range of the LED elements that are turned on.

According to an embodiment of the disclosure, the air conditioner 100 may increase the width of a light turn-on section as the compressor frequency increases, and may decrease the width of the light turn-on section as the compressor frequency decreases. According to an embodiment of the disclosure, the air conditioner 100 may define a certain number of ranges of compressor frequency, and define the width of a light turn-on section for each range.

An example in which the compressor frequency is a high frequency, which is a relatively high frequency, and an example in which the compressor frequency is a low frequency, which is a relatively low frequency, will be described with reference to FIG. 7. In addition, an example in which the light 114 corresponds to a line-shaped light will be described with reference to FIG. 7. The air conditioner 100 may set the light turn-on section to section 720a when the compressor frequency is a high frequency, and may set the light turn-on section to section 720b when the compressor frequency is a low frequency. Section 720a corresponds to a wider width than section 720b.

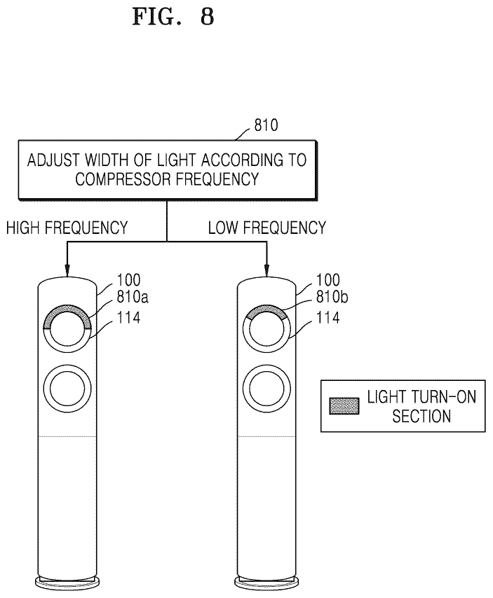

FIG. 8 is a diagram illustrating a process of controlling a light in a first mode, according to an embodiment of the disclosure.

According to an embodiment of the disclosure, the air conditioner 100 may include a circular light 114. For example, the air conditioner 100 may be implemented as a stand type, and the light 114 may be provided in a circular or elliptical shape around the air discharge port. Other shapes may be used in other examples. According to an embodiment of the disclosure, in operation 810, the air conditioner 100 may adjust the width of a turn-on section of the light 114 according to the compressor frequency of the compressor 120.

An example in which the compressor frequency is a high frequency, which is a relatively high frequency, and an example in which the compressor frequency is a low frequency, which is a relatively low frequency, will be described with reference to FIG. 8. When the compressor frequency corresponds to a high frequency, the air conditioner 100 may turn on a section 810a of the light 114. When the compressor frequency corresponds to a low frequency, the air conditioner 100 may turn on a section 810b of the light 114. According to an embodiment of the disclosure, as illustrated in FIG. 8, the width of a turn-on section of the circular or elliptical light 114 may be adjusted according to the compressor frequency.

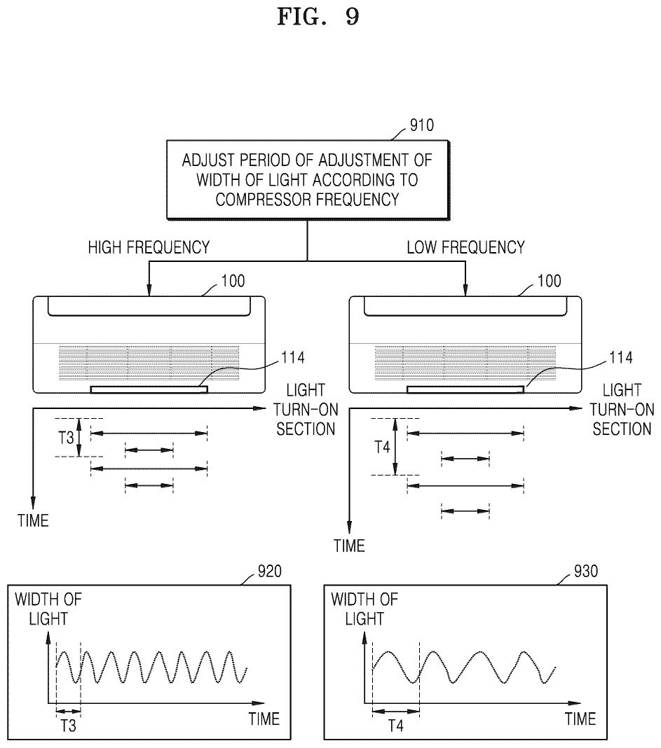

FIG. 9 is a diagram illustrating a process of controlling a light in a first mode, according to an embodiment of the disclosure.

According to an embodiment of the disclosure, in operation 910, while operating in the first mode, the air conditioner 100 may adjust a change period of the width of a turn-on section of the light 114. In the first mode, the air conditioner 100 may periodically change the width of the turn-on section of the light 114. For example, the air conditioner 100 may change the width of the turn-on section of the light 114 in the form of a sine function, as in a pattern 920 and a pattern 930. According to an embodiment of the disclosure, the air conditioner 100 may adjust the period of changing the width of the turn-on section of the light 114 according to the compressor frequency. For example, the air conditioner 100 may decrease the change period of the width of a light turn-on section as the compressor frequency increases, and may increase the change period of the width of the light turn-on section as the compressor frequency decreases. According to an embodiment of the disclosure, the air conditioner 100 may define a certain number of ranges of compressor frequency, and define the change period of the width of a light turn-on section for each range.

An example in which the compressor frequency is a high frequency, which is a relatively high frequency, and an example in which the compressor frequency is a low frequency, which is a relatively low frequency, will be described with reference to FIG. 9. In addition, an example in which the light 114 corresponds to a line-shaped light will be described with reference to FIG. 9. The air conditioner 100 may set the change period of a light turn-on section to T3 when the compressor frequency is a high frequency, and may set the change period of the light turn-on section to T4 when the compressor frequency is a low frequency. T3 corresponds to a shorter period than T4.

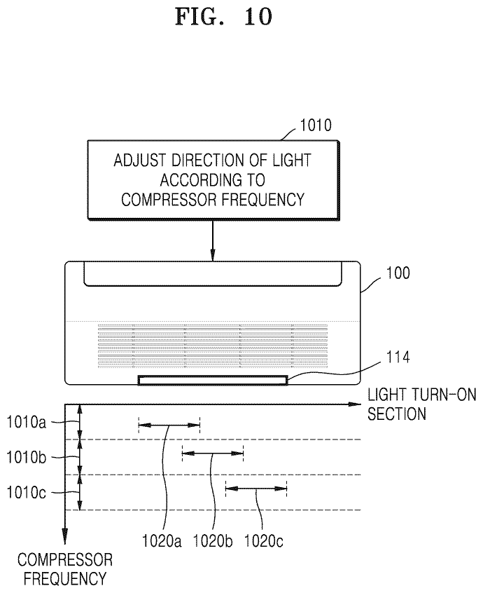

FIG. 10 is a diagram illustrating a process of controlling a light in a first mode, according to an embodiment of the disclosure.

An example in which the light 114 corresponds to a line-shaped light will be described with reference to FIG. 10.

According to an embodiment of the disclosure, in operation 1010, while operating in the first mode, the air conditioner 100 may adjust the direction of a turn-on section of the light 114 according to the compressor frequency. The air conditioner 100 may adjust the direction of the turn-on section of the line-shaped light 114 in the left and right directions. The air conditioner 100 may adjust the direction of the light 114 by adjusting turn-on sections of a plurality of elements of the light 114. For example, the air conditioner 100 may adjust the direction of the light 114 by turning on the light 114 in a section 1020a for a low frequency and turning on the light in a section 1020c for a high frequency.

According to an embodiment of the disclosure, the air conditioner 100 may define a certain number of ranges of compressor frequency, and define the direction of the light 114 for each range. The number of ranges of compressor frequency may be variously determined. For example, the air conditioner 100 may define three compressor frequency ranges 1010a, 1010b, and 1010c. The frequency ranges 1010a, 1010b, and 1010c correspond to higher frequency ranges in that order. Other numbers of frequency ranges can be implemented in other examples. According to an embodiment of the disclosure, in the frequency range 1010a, the light 114 in the section 1020a may be turned on, in the frequency range 1010b, the light 114 in a section 1020b may be turned on, and in the frequency range 1010c, the light 114 in the section 1020c may be turned on. According to an embodiment of the disclosure, information about the compressor frequency may be intuitively provided in the first mode by adjusting the direction of the light 114 according to the compressor frequency.

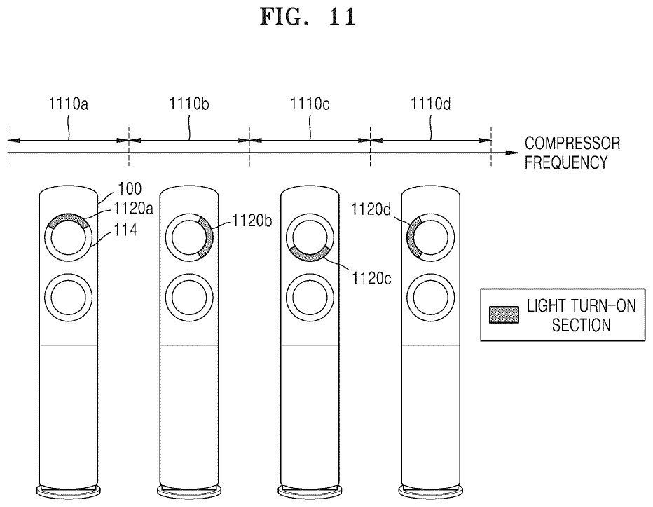

FIG. 11 is a diagram illustrating a process of controlling a light in a first mode, according to an embodiment of the disclosure.

An example in which the light 114 corresponds to a circular or elliptical light will be described with reference to FIG. 11.

According to an embodiment of the disclosure, while operating in the first mode, the air conditioner 100 may adjust the direction of a turn-on section of the light 114 according to the compressor frequency. The air conditioner 100 may adjust an angle range of the turn-on section of the circular or elliptical light 114. The air conditioner 100 may adjust the angle range of the turn-on section of the light 114 by adjusting turn-on sections of a plurality of elements of the light 114.

According to an embodiment of the disclosure, the air conditioner 100 may define a certain number of ranges of compressor frequency, and define a turn-on section of the light 114 for each range. The number of ranges of compressor frequency may be variously determined. For example, the air conditioner 100 may define four compressor frequency ranges 1110a, 1110b, 1110c, and 1110d. The frequency ranges 1110a, 1110b, 1110c, and 1110d correspond to higher frequency ranges in that order. According to an embodiment of the disclosure, in the frequency range 1110a, the light 114 in a section 1120a may be turned on, in the frequency range 1110b, the light 114 in a section 1120b may be turned on, in the frequency range 1110c, the light 114 in the section 1120c may be turned on, and in the frequency range 1110d, the light 114 in the section 1120d may be turned on. According to an embodiment of the disclosure, information about the compressor frequency may be intuitively provided in the first mode by adjusting the angle range of the turn-on section of the light 114 according to the compressor frequency.

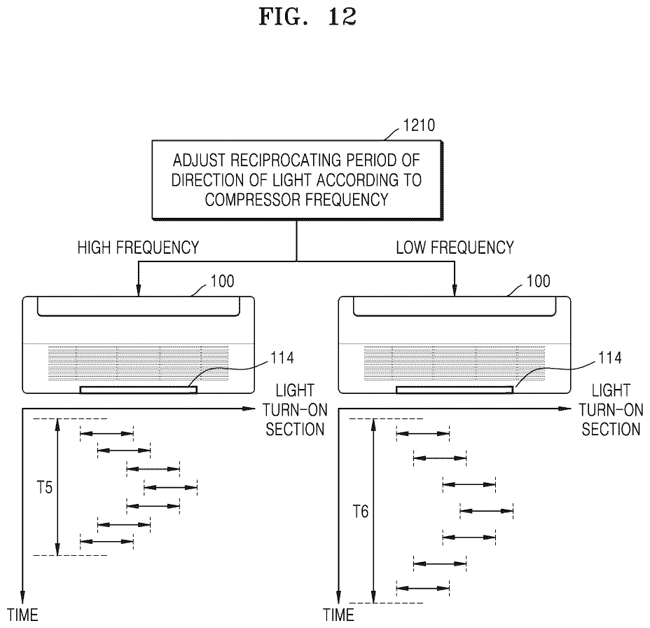

FIG. 12 is a diagram illustrating a process of controlling a light in a first mode, according to an embodiment of the disclosure.

An example in which the light 114 corresponds to a line-shaped light will be described with reference to FIG. 12.

According to an embodiment of the disclosure, in the first mode, the air conditioner 100 may periodically move a turn-on section of the light 114. For example, the air conditioner 100 may reciprocate the turn-on section of the light 114 between the left side and the right side at a predetermined period. In operation 1210, while operating in the first mode, the air conditioner 100 may adjust a reciprocating period of the turn-on section of the light 114 according to the compressor frequency. For example, the air conditioner 100 may reciprocate the turn-on section of the light 114 at a period of T5 for a high frequency, and may reciprocate the turn-on section of the light 114 at a period of T6 for a low frequency. T5 may correspond to a shorter period than T6.

According to an embodiment of the disclosure, the air conditioner 100 may define a certain number of ranges of compressor frequency, and define a reciprocating period of the turn-on section of the light 114 for each range. The number of ranges of compressor frequency may be variously determined. For example, the air conditioner 100 may define three compressor frequency ranges. According to an embodiment of the disclosure, information about the compressor frequency may be intuitively provided in the first mode by adjusting the reciprocating period of the turn-on section of the light 114 according to the compressor frequency.

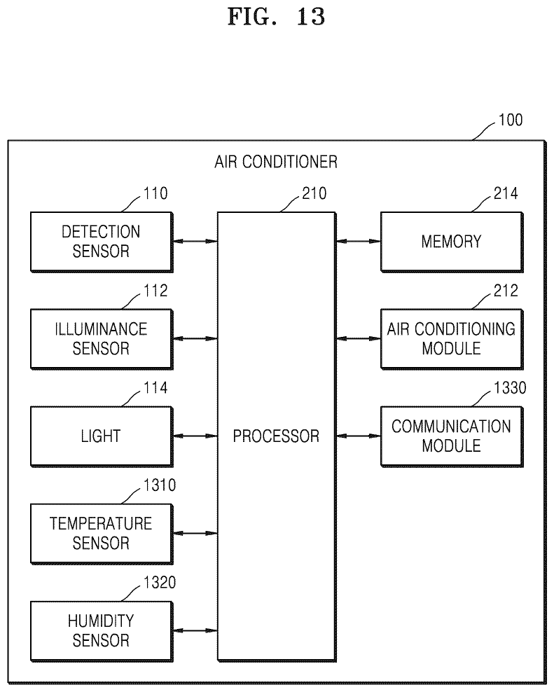

Hereinafter, an embodiment of the disclosure in which the air conditioner 100 learns power consumption according to environmental information and provides a notification about an abnormal operation will be described with reference to FIGS. 13, 14, 15, 16, and 17.

FIG. 13 is a block diagram illustrating a structure of an air conditioner according to an embodiment of the disclosure.

According to an embodiment of the disclosure, the air conditioner 100 may include the detection sensor 110, the illuminance sensor 112, the light 114, the processor 210, the air conditioning module 212, the memory 214, a temperature sensor 1310, a humidity sensor 1320, and a communication module 1330. The block diagram of the air conditioner 100 of FIG. 13 may correspond to a block diagram of an indoor unit. In describing FIG. 13, redundant descriptions provided above with reference to FIG. 2 will be omitted, and the description will focus on the difference from the embodiment of FIG. 2.

The detection sensor 110 may detect an object in the target space 140. The detection sensor 110 generates a sensor detection value and transmits it to the processor 210.

The illuminance sensor 112 is a sensor configured to measure the brightness of the target space 140. The illuminance sensor 112 may generate an illuminance value and transmit it to the processor 210.

The light 114 is a device configured to output light toward the target space 140. The light 114 may be embedded in or coupled to the housing of the air conditioner 100 to radiate or emit light around the air conditioner 100.

The processor 210 controls the overall operation of the air conditioner 100. The processor 210 may be implemented as one or more processors. The processor 210 may execute instructions or commands stored in the memory 214 to perform a certain operation. In addition, the processor 210 controls the operation of components provided in the air conditioner 100.

The air conditioning module 212 performs an air conditioning operation. The air conditioning module 212 adjusts whether to perform cooling, cooling intensity, whether to perform heating, heating intensity, an airflow volume, and the like, based on a control signal or a driving signal input from the processor 210. The air conditioning module 212 may include a heat exchanger, a motor, an inverter, a fan, a filter, and the like. In addition, the air conditioning module 212 may include the outdoor unit 116, and the outdoor unit 116 may include the compressor 120. The processor 210 may set the compressor frequency of the compressor 120 of the outdoor unit 116 according to the difference between the indoor temperature and the set temperature.

The memory 214 stores various pieces of information, data, instructions, programs, and the like necessary for the operation of the air conditioner 100.

The temperature sensor 1310 detects the temperature of the target space 140. The temperature sensor 1310 may include a temperature sensor such as a thermocouple, a resistance temperature device (RTD), a thermistor, an infrared thermometer, or a bimetal. The temperature sensor 1310 outputs a detected temperature value to the memory 214 or the processor 210.

The humidity sensor 1320 detects the humidity of the target space 140. The humidity sensor 1320 detects humidity and outputs it as an electrical signal. The humidity sensor 1320 may include, for example, an electrical resistance sensor or a capacitive sensor. The humidity sensor 1320 outputs a detected humidity value to the memory 214 or the processor 210.

The communication module 1330 may communicate with at least one external device in a wired or wireless manner. According to an embodiment of the disclosure, the communication module 1330 perform wireless communication with a remote controller. The communication module 1330 may receive, from the remote controller, a power on/off signal, a temperature setting signal, an operation mode selection signal, a blowing intensity selection signal, a sleep scheduling signal, a sleep mode control signal, a scheduled operation setting signal, an airflow direction setting signal, or the like. The communication module 1330 may transmit state information of the air conditioner 100 to the remote controller in order to synchronize state information of the remote controller and the air conditioner 100.

In addition, the communication module 1330 may receive, from the remote controller, a control signal for controlling the light 114. For example, the communication module 1330 may receive, from the remote controller, an on/off control signal, a luminous intensity control signal, an automatic on/off control signal, and the like for the light 114. In addition, the communication module 1330 may receive, from the remote controller, a control signal for activating or deactivating control of the light 114 according to the first mode and the second mode described above.

In addition, according to an embodiment of the disclosure, the communication module 1330 may communicate with the outdoor unit 116. For example, the communication module 1330 may communicate with the outdoor unit 116 by using RS-485 serial communication.

In addition, according to an embodiment of the disclosure, the communication module 1330 may communicate with a server through a network. The communication module 1330 may access the network through an AP device, and communicate with the server. In addition, the communication module 1330 may receive, from the server, a power on/off signal, a temperature setting signal, an operation mode selection signal, a blowing intensity selection signal, a sleep scheduling signal, a sleep mode setting signal, a scheduled operation setting signal, an airflow direction setting signal, or the like. The communication module 1330 may transmit state information of the air conditioner 100 to the server in order to synchronize state information of the server and the air conditioner 100. In addition, the communication module 1330 may receive, from the server, an operation mode or setting information of the air conditioner 100, which is set by using a user terminal or the like.

In addition, the communication module 1330 may receive, from the server, a control signal for controlling the light 114. For example, the communication module 1330 may receive, from the server, an on/off control signal, a luminous intensity control signal, an automatic on/off control signal, and the like for the light 114. In addition, the communication module 1330 may receive, from the server, a control signal for activating or deactivating control of the light 114 according to the first mode and the second mode described above.

The processor 210 may control the operation of each component of the air conditioner 100 according to a control signal received from the remote controller or the server through the communication module 1330.

The communication module 1330 may include a wireless communication module (e.g., a cellular communication module, a short-range wireless communication module, or a global navigation satellite system (GNSS) communication module) or a wired communication module (e.g., a LAN communication module or a power line communication module). In addition, the communication module 1330 may perform short-range communication, and may use, for example, Bluetooth, BLE, NFC, WLAN (Wi-Fi), Zigbee, IrDA communication, WFD, UWB, Ant+ communication, and the like. In addition, for example, the communication module 1330 may perform long-range communication, and may communicate with an external device through, for example, a legacy cellular network, a 5G network, a next-generation communication network, the Internet, a computer network (e.g., a LAN or a WAN), or the like.

In addition, for example, the communication module 1330 may use mobile communication, and may transmit and receive wireless signals to and from at least one of a base station, an external terminal, or a server, on a mobile communication network.

According to an embodiment of the disclosure, the communication module 1330 is connected to an AP inside a home through Wi-Fi communication. The communication module 1330 may communicate with an external device through the AP.

According to an embodiment of the disclosure, the air conditioner 100 may learn power consumption of the air conditioner 100 according to environmental information about the target space 140, and detect an abnormal operation of the air conditioner 100 by comparing the learned power consumption with the current power consumption. In addition, when an abnormal operation is detected, the air conditioner 100 may provide a notification about the abnormal operation by using an output interface of the air conditioner 100 or an external device.

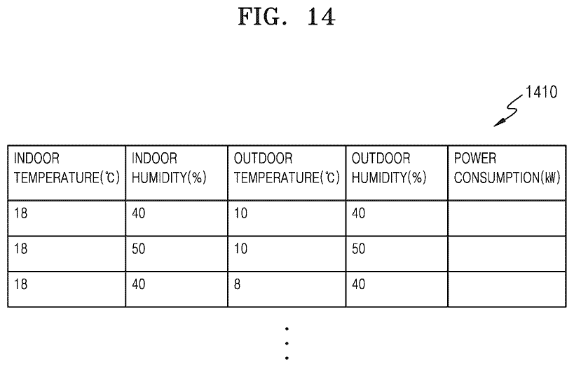

FIG. 14 is a diagram showing power consumption learned according to environmental information, according to an embodiment of the disclosure.

An embodiment of the disclosure in which the air conditioner 100 learns power consumption according to environmental information, and provides information about an abnormal operation will be described with reference to FIGS. 13 and 14.

According to an embodiment of the disclosure, the processor 210 may collect environmental information about the target space 140, and power consumption information about the air conditioner 100 corresponding to each environmental information. The environmental information may include at least one of an indoor temperature, an indoor humidity, an outdoor temperature, or an outdoor humidity. The processor 210 may collect indoor temperature information by using a temperature value detected by the temperature sensor 1310. In addition, the processor 210 may collect indoor humidity information by using a humidity value detected by the humidity sensor 1320.

According to an embodiment of the disclosure, the outdoor unit 116 may include a temperature sensor or a humidity sensor. The processor 210 may collect outdoor temperature information by using a temperature value detected by the temperature sensor provided in the outdoor unit 116. In addition, the processor 210 may collect outdoor humidity information by using a humidity value detected by the humidity sensor provided in the outdoor unit 116.

The air conditioner 100 may include a power module. The power module receives power from an external power source, converts a current and a voltage, and supplies power to each component of the air conditioner 100. The processor 210 may collect information about power consumption from the power module.

As shown in FIG. 14, the processor 210 may collect environmental information and power consumption of the air conditioner 100, and learn the power consumption corresponding to each environmental information. The processor 210 may store the collected environmental information and power consumption in the memory 214. The processor 210 may collect a certain number of pieces of power consumption information for the same environmental conditions, and learn the power consumption corresponding to each environmental condition. For example, the processor 210 may accumulate substantially 20 or more pieces of power consumption information for each environmental condition, and define power consumption information in each environmental condition as shown in a first table 1410 of FIG. 14 by using the accumulated data.

The same environmental condition means a condition in which each parameter included in the environmental information, that is, an indoor temperature, an indoor humidity, an outdoor temperature, and an outdoor humidity, is the same. The processor 210 may fill the first table 1410 with power consumption values for the respective environmental conditions, by learning the collected data. The processor 210 may store the first table 1410 in the memory 214 and update the first table 1410 while performing learning.

According to an embodiment of the disclosure, learning of power consumption for each environmental condition may be performed by a server. The server may collect environmental information and power consumption information from the air conditioner 100 and learn the power consumption according to each environmental condition. The server may provide the air conditioner 100 with the learned power consumption information according to the environmental conditions.

When learning of power consumption according to environmental conditions is completed, the air conditioner 100 determines whether the power consumption is normal under the current environmental condition, by using the learned data. The processor 210 may determine whether the power consumption is normal, based on a difference value between the power consumption in the current environmental condition and the learned power consumption. For example, when the difference value between the current power consumption and the learned power consumption is substantially 50% or greater of the learned power consumption, the processor 210 may determine that the power consumption is abnormal. For example, when the difference value between the current power consumption and the learned power consumption is less than substantially 50% of the learned power consumption, the processor 210 may determine that the power consumption is normal. The criteria for determining whether power consumption is abnormal may be variously determined depending on the embodiment.

According to an embodiment of the disclosure, when it is determined that the power consumption is abnormal, the air conditioner 100 provides a notification to the user. When it is determined that the power consumption is abnormal, the processor 210 may provide an external device with an abnormal operation notification that the power consumption is abnormal. The processor 210 may transmit an abnormal operation notification to the server through the communication module 1330. The server may provide the abnormal operation notification to an external device to output the abnormal operation notification to the user through the external device.

In addition, according to an embodiment of the disclosure, the processor 210 may output an abnormal operation notification through an output interface provided in the air conditioner 100 or a remote controller. According to an embodiment of the disclosure, the processor 210 may output an abnormal operation notification by outputting an optical signal in a defined pattern through the light 114.

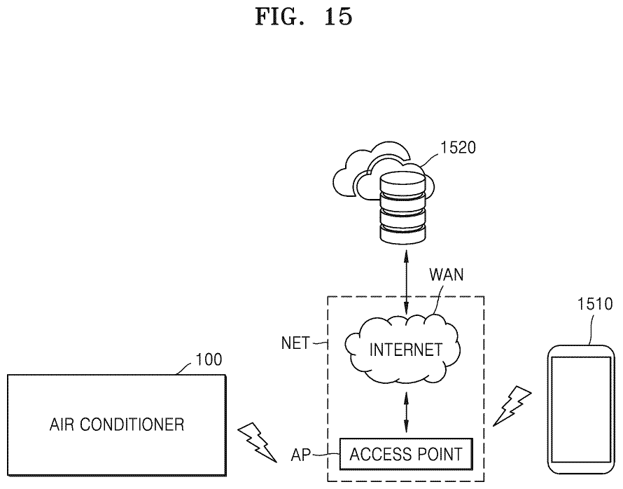

FIG. 15 is a diagram illustrating an air conditioner, an external device, and a server, according to an embodiment of the disclosure.

According to an embodiment of the disclosure, the air conditioner 100 communicates with an external device 1510 and a server 1520 through the communication module 1330. The air conditioner 100 may be connected to other home appliances, the external device 1510, or the server 1520, through a network NET 1530.

The server 1520 may manage user account information and information about the air conditioner 100 connected to a user account. For example, a user may connect to the server 1520 through the external device 1510 and generate a user account. The user account may be identified by an identifier (ID) and a password both set by the user. The server 1520 may register the air conditioner 100 to the user account according to a set procedure. For example, the server 1520 may register the air conditioner 100 by linking identification information (e.g., a serial number or a medium access control (MAC) address) of the air conditioner 100 to the user account.

The external device 1510 may include a communication module capable of communicating with the air conditioner 100 and the server 1520, a user interface configured to receive a user input or output information to the user, at least one processor configured to control the operation of the external device 1510, and at least one memory storing a program for controlling the operation of the external device 1510.

The external device 1510 may be carried by the user or arranged in the user's home or office. The external device 1510 may include, for example, a personal computer, a terminal, a portable telephone, a smart phone, a handheld device, a wearable device, and the like, but is not limited thereto.

A program (e.g., an application) for controlling the air conditioner 100 may be stored in the memory of the external device 1510. The external device 1510 may be sold with an application for controlling the air conditioner 100 installed therein, or may be sold without the application. In a case in which the external device 1510 is sold without an application for controlling the air conditioner 100, the user may download the application from an external server that provides applications and install it on the external device 1510.

The user may control the air conditioner 100 by using the application installed on the external device 1510. For example, when the user executes the application installed on the external device 1510, identification information of the air conditioner 100 connected to the same user account as the external device 1510 may be shown in an application execution window. The user may perform desired control on the air conditioner 100 through the application execution window. When the user inputs a control command for the air conditioner 100 through the application execution window, the external device 1510 may transmit the control command directly to the air conditioner 100 through a LAN, or may transmit the control command to the air conditioner 100 via the server 1520.

The application of the external device 1510 may receive various user inputs for controlling the air conditioner 100. The application provides a graphical user interface (GUI) to receive various user inputs, and receives a user input through the GUI. The external device 1510 communicates with the server 1520 to update state information of the air conditioner 100, and provide the state information through the application. In addition, the external device 1510 communicates with the server 1520 to transmit, to the air conditioner 100, a user input received through the application.

The application may receive a power-off signal or a termination reservation signal for the air conditioner 100. In addition, the application may receive a reservation setting signal and receive a user input for setting a reservation end time. In addition, the application may receive a sleep mode setting signal and receive a user input for setting a reservation end time. In addition, the application may receive a user input for setting a noise prevention mode. In addition, the application may receive a user input for setting an automatic drying function. In addition, the application may receive a user input for setting a wind-free mode.

In addition, the application may receive a user input for selecting a user-specified mode. In addition, according to an embodiment of the disclosure, the application may receive a user input for controlling the light 114 of the air conditioner 100.

The network NET may include both a wired network and a wireless network. The wired network includes a cable network or a telephone network, and the wireless network may include any network for transmitting and receiving signals through radio waves. The wired network and the wireless network may be connected to each other.

The network NET may include a WAN such as the Internet, a LAN configured around an AP, and a wireless personal area network (WPAN) that does not go through an AP. The short-range wireless network may include Bluetooth™ (Institute of Electrical and Electronics Engineers (IEEE) 802.15.1), Zigbee (IEEE 802.15.4), WFD, NFC, Z-Wave, and the like, but is not limited thereto.

The AP may connect a LAN to which the air conditioner 100 and the external device 1510 are connected, to a WAN to which the server 1520 is connected. The air conditioner 100 or the external device 1510 may be connected to the server 1520 through the WAN.

The AP may include a device that allows devices to connect to each other by using related standards using Wi-Fi in a computer network.

According to embodiments of the disclosure, the AP may include an AP implemented in a hardware manner, and an AP implemented in a software manner.

For example, the AP may relay data between a wireless device and a wired device on a network. However, the disclosure is not limited thereto, and the AP 1540 may relay data between wired devices or between wireless devices. In addition, the AP 1540 may also be referred to as a relay device.

The AP may communicate with the air conditioner 100 and the external device 1510 by using wireless communication such as Wi-Fi™ (IEEE 802.11), and may connect to a WAN by using wired communication.

The air conditioner 100 may transmit information about an operation or a state to the server 1520 through the network NET. For example, the air conditioner 100 may transmit information about an operation or a state to the server 1520 through Wi-Fi™ (IEEE 802.11) communication.

In a case in which the air conditioner 100 is not equipped with a Wi-Fi communication module, the air conditioner 100 may transmit information about an operation or a state to the server 1520 through another home appliance having a Wi-Fi communication module. For example, when the air conditioner 100 transmits information about an operation or a state to another home appliance through a short-range wireless network (e.g., BLE communication), the other home appliance may transmit the information about the operation or state of the air conditioner 100 to the server 1520. In addition, for example, in a case in which the air conditioner 100 is not equipped with a Wi-Fi communication module, the air conditioner 100 may be connected to a communication relay device by wire, and perform Wi-Fi communication and RS-485 communication through the communication relay device.

The air conditioner 100 may provide information about an operation or a state of the air conditioner 100 to the server 1520 according to the user's prior approval. Information transmission to the server 1520 may occur when a request is received from the server 1520, may occur when a particular event occurs in the air conditioner 100, or may occur periodically or in real time.

When the server 1520 receives information about an operation or a state from the air conditioner 100, the server 1520 may update previously stored information related to the air conditioner 100. The server 1520 may transmit information about an operation or a state of the air conditioner 100 to the external device 1510 through the network NET 1530.

When a request is received from the external device 1510, the server 1520 may transmit information about an operation or a state of the air conditioner 100 to the external device 1510. For example, when the user executes, on the external device 1510, an application connected to the server 1520, the external device 1510 may request and receive information about an operation or a state of the air conditioner 100 from the server 1520 through the application. When information about an operation or a state is received from the air conditioner 100, the server 1520 may transmit information about an operation or a state of the air conditioner 100 to the external device 1510 in real time. The server 1520 may periodically transmit information about an operation or a state of the air conditioner 100 to the external device 1510. The external device 1510 may deliver information about an operation or a state of the air conditioner 100 to the user by displaying the information about the operation or state of the air conditioner 100 on an application execution window.

The air conditioner 100 may obtain various pieces of information from the server 1520 and provide the obtained information to the user. In addition, the air conditioner 100 may receive, from the server 1520, a file for updating pre-installed software or data related to the pre-installed software, and update the pre-installed software or the data related to the pre-installed software based on the received file.

The air conditioner 100 may operate according to a control command received from the server 1520. For example, in a case in which the air conditioner 100 obtains prior approval from the user to operate according to a control command of the server 1520 even without a user input, the air conditioner 100 may operate according to a control command received from the server 1520. The control command received from the server 1520 may include a control command input by the user through the external device 1510 or a control command generated by the server 1520 based on preset conditions, but is not limited thereto.

According to an embodiment of the disclosure, the server 1520 may store a result of learning power consumption according to environmental conditions. The server 1520 may store a results of learning power consumption according to environmental conditions in a user account to which the air conditioner 100 is registered. When learning is performed by the air conditioner 100, the server 1520 may receive, from the air conditioner 100, a result of learning power consumption according to environmental conditions, and store the received learning result in the user account to which the air conditioner 100 is registered. The server 1520 may store an installation location, installation conditions, and the like of the air conditioner 100 corresponding to the learning result together. When the server 1520 learns power consumption according to environmental conditions, the server 1520 may store the learned power consumption according to the environmental conditions in the user account to which the air conditioner 100 is registered.

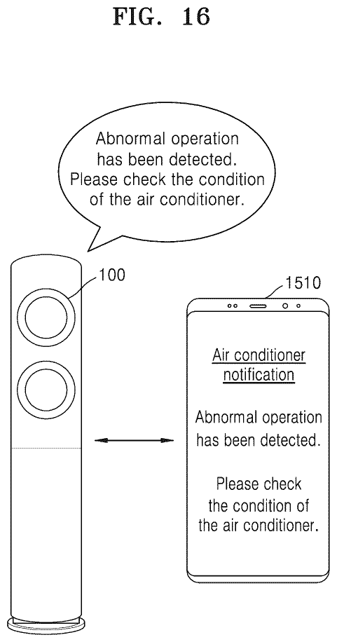

FIG. 16 is a diagram illustrating an operation of providing an abnormal operation notification, according to an embodiment of the disclosure.

According to an embodiment of the disclosure, when an abnormal operation is detected, the air conditioner 100 may provide an abnormal operation notification. The abnormal operation notification may include a text and/or audio message that an abnormal operation has been detected, an air conditioner status check guide, information about excessive power consumption, information about reduced cooling performance, or the like. The air conditioner status check guide may include a request to check a window, a request to check a refrigerant leak, a request to check a hose connection, a request to check the operation of the outdoor unit, a request to check opening of the air conditioner outlet, a request to check a water leak, or the like.

According to an embodiment of the disclosure, the air conditioner 100 may output an abnormal operation notification through the output interface of the air conditioner 100. The output interface of the air conditioner 100 may include, for example, a display, a speaker, the light 114, or the like. According to an embodiment of the disclosure, the air conditioner 100 may display an abnormal operation notification through the display.

In addition, according to an embodiment of the disclosure, the air conditioner 100 may output an abnormal operation notification through the external device 1510. The air conditioner 100 may transmit abnormal operation information to the server 1520 through the communication module 1330. The server 1520 may request to output an abnormal operation notification to the external device 1510 registered to the same user account as the air conditioner 100. The external device 1510 may output an abnormal operation notification through an output interface. When the external device 1510 receives an abnormal operation notification, the external device 1510 may output the abnormal operation notification through an application for controlling the air conditioner 100.

According to an embodiment of the disclosure, an abnormal operation notification may be output through any one of the air conditioner 100 and the external device 1510. In addition, according to an embodiment of the disclosure, the air conditioner 100 and the external device 1510 may output an abnormal operation notification together.

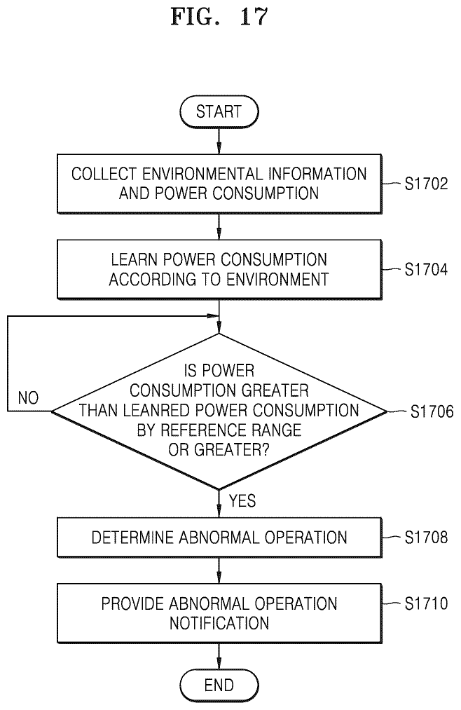

FIG. 17 is a flowchart of a method of controlling an air conditioner, according to an embodiment of the disclosure.

Referring to FIG. 17, in operation S1702, the air conditioner 100 collects environmental information about the target space 140 and the power consumption of the air conditioner 100. The environmental information is information indicating the environmental conditions of the target space 140. The environmental information may include, for example, at least one of an indoor temperature, an indoor humidity, an outdoor temperature, or an outdoor humidity. According to an embodiment of the disclosure, the air conditioner 100 may obtain indoor temperature information by using the temperature sensor 1310 of the indoor unit, and obtain indoor humidity information by using the humidity sensor 1320 of the indoor unit. In addition, according to an embodiment of the disclosure, outdoor temperature information may be obtained by using the temperature sensor of the outdoor unit, and outdoor humidity information may be obtained by using the humidity sensor of the outdoor unit.

According to an embodiment of the disclosure, after the air conditioner 100 is installed in the target space 140, in operation S1702, the air conditioner 100 may collect environmental information and power consumption. The air conditioner 100 may obtain identification information or location information about the target space 140, and collect environmental information and power consumption corresponding to the identification information or location information.

According to an embodiment of the disclosure, the air conditioner 100 may obtain environmental information by using an external temperature sensor or humidity sensor. The air conditioner 100 may receive indoor temperature information, indoor humidity information, outdoor temperature information, or outdoor humidity information, from the external temperature sensor or humidity sensor through the communication module 1330. For example, the air conditioner 100 may obtain indoor temperature information by using a temperature sensor arranged in the target space 140, or obtain indoor humidity information by using a humidity sensor arranged in the target space 140. In addition, for example, the air conditioner 100 may obtain outdoor temperature information by using a temperature sensor arranged outdoors, or may obtain outdoor humidity information by using a humidity sensor arranged outdoors.

According to an embodiment of the disclosure, the air conditioner 100 may collect environmental information by using various combinations of a temperature sensor and a humidity sensor provided in the indoor unit or the outdoor unit of the air conditioner 100, and a temperature sensor and a humidity sensor provided in an external device.

In addition, the air conditioner 100 collects power consumption information according to environmental information. The air conditioner 100 may obtain information about power consumption from the power module of the air conditioner 100.

Next, in operation S1704, the air conditioner 100 learns the power consumption of the air conditioner 100 according to the environmental information. The air conditioner 100 learns the power consumption for each environmental condition defined by the environmental information. The air conditioner 100 accumulates a defined number or more of pieces of power consumption information for each environmental condition. The air conditioner 100 learns the power consumption for each environmental condition by using the accumulated power consumption information for each environmental condition. The air conditioner 100 may learn power consumption for each environmental condition by using various types of learning algorithms. In addition, according to an embodiment of the disclosure, the air conditioner 100 may learn the power consumption for each environmental condition by calculating an average value of training data for power consumption in each environmental condition.

According to an embodiment of the disclosure, after initial installation, the air conditioner 100 may learn power consumption according to environmental conditions. When the air conditioner 100 completes learning of power consumption for certain environmental conditions, in operation S1706, the air conditioner 100 may use the learned power consumption value. The air conditioner 100 may not perform operation S1706 for an environmental condition for which learning of power consumption has not been completed.

Next, in operation S1706, the air conditioner 100 determines whether the current power consumption is greater than the learned power consumption for the current environmental condition by a reference range or greater. The air conditioner 100 may obtain current environmental information and obtain the learned power consumption value for an environmental condition corresponding to the current environmental information. In addition, the air conditioner 100 may obtain the current power consumption value. The air conditioner 100 determines whether the current power consumption value is greater than the learned power consumption value corresponding to the current environmental condition by a reference range or greater. The reference range is, for example, a value corresponding to a predetermined proportion of the learned power consumption. For example, the reference range is a value corresponding to 50% of the learned power consumption. The air conditioner 100 may determine whether the current power consumption is greater than the learned power consumption value for the current environmental condition by 50% or greater.

When it is determined in operation S1706 that the current power consumption is greater than the learned power consumption by the reference range or greater, in operation S1708, the air conditioner 100 determines that the air conditioner 100 is in an abnormal operation.

When it is determined that the air conditioner 100 is in abnormal operation, in operation S1710, the air conditioner 100 provides an abnormal operation notification. For example, the air conditioner 100 may provide the abnormal operation notification through the external device 1510. In addition, for example, the air conditioner 100 may provide the abnormal operation notification through the output interface of the air conditioner 100.

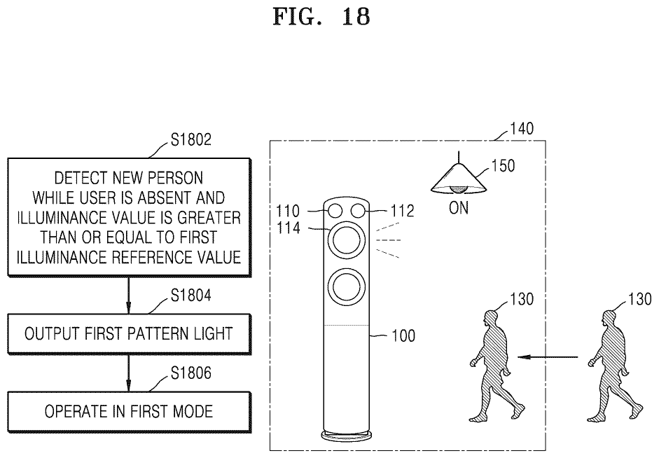

FIG. 18 is a diagram illustrating an operation of an air conditioner when a new user is detected in a target space, according to an embodiment of the disclosure.

According to an embodiment of the disclosure, when a new user 130 is detected while the user is absent in the target space 140, the air conditioner 100 may output a lighting pattern corresponding to the entrance of the user 130 by using the light 114. For example, the air conditioner 100 may output welcome lighting corresponding to the entrance of the user 130.

In operation S1802, the air conditioner 100 may detect the new user 130 entering the target space 140 in a state in which the illuminance value of the target space 140 is greater than or equal to the first illuminance reference value. When the illuminance value is greater than or equal to the first illuminance reference value and the air conditioner 100 determines that the user 130 is not detected in the target space 140 and thus is absent, the air conditioner 100 maintains the light 114 in an off state.

When the illuminance value is greater than the first illuminance reference value and the new user 130 is detected while the light 114 is turned off as described above, in operation S1804, the air conditioner 100 outputs an optical signal in a first pattern through the light 114. The optical signal in the first pattern is an optical signal that responds to the user 130 entering the space. The first pattern may correspond to a dimming pattern, a blinking pattern, a reciprocating pattern, a rotating pattern, or the like.

After outputting the optical signal in the first pattern through the light 114 for a reference time period, in operation S1806, the air conditioner 100 may operate in the first mode in which the luminous intensity or a luminous intensity change pattern of the light 114 is controlled according to the compressor frequency.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or memory of a relay server.

According to an aspect of an embodiment of the disclosure, an air conditioner is provided. The air conditioner includes a detection sensor configured to detect an object, an illuminance sensor configured to detect an illuminance of a target space, a light, an air conditioning module comprising a compressor, at least one processor, and a memory storing at least one instruction, when executed by the at least one processor individually or collectively, cause the air conditioner to determine whether an illuminance value detected by the illuminance sensor is greater than or equal to a first illuminance reference value, detect a human in the target space by using a sensor detection value of the detection sensor, and based on the detected illuminance value being greater than or equal to the first illuminance reference value and a human being detected in the target space, control the light in a first mode in which at least one of luminous intensity or a luminous intensity change pattern of the light is controlled based on a compressor frequency of the compressor of the air conditioning module.

According to an embodiment of the disclosure, the at least one processor 210 may be further configured to execute the at least one instruction to, based on the detected illuminance value being less than or equal to a second illuminance reference value that is less than the first illuminance reference value, and a human being detected in the target space, control the light 114 in a second mode in which the light 114 is turned on at a first level of luminous intensity.

According to an embodiment of the disclosure, the luminous intensity change pattern may include at least one of a luminous intensity level pattern, a light blinking period, a light blinking pattern, or a turn-on section width change.

According to an embodiment of the disclosure, the luminous intensity change pattern may correspond to a periodic dimming pattern.

According to an embodiment of the disclosure, the luminous intensity change pattern may correspond to a direction change pattern of the light 114.

According to an embodiment of the disclosure, the light 114 may include a line-shaped LED light, and the at least one processor 210 may be further configured to execute the at least one instruction to change a direction of the light 114 by changing a turn-on section of the LED light over time.

According to an embodiment of the disclosure, the at least one processor 210 may be further configured to execute the at least one instruction to adjust the luminous intensity of the light 114 according to an ambient illuminance detected by the illuminance sensor 112.

According to an embodiment of the disclosure, the at least one processor 210 may be further configured to execute the at least one instruction to learn power consumption of the air conditioner 100 according to an environment of the target space, based on power consumption of the air conditioner 100 in a current environment being greater than the learned power consumption by a reference proportion, determine that the air conditioner 100 is in an abnormal operation, and based on determining that the air conditioner 100 is in the abnormal operation, provide an abnormal operation notification to a user.

According to an embodiment of the disclosure, the air conditioner 100 may further include a temperature sensor 1310 and a humidity sensor 1320, and the environment of the target space may be defined by at least one of an indoor temperature, an indoor humidity, an outdoor temperature, or an outdoor humidity.

According to an embodiment of the disclosure, the air conditioner 100 may further include a communication module 1330, and the at least one processor 210 may be further configured to execute the at least one instruction to provide the abnormal operation notification to an external device through the communication module 1330.

According to an embodiment of the disclosure, the air conditioner 100 may further include a temperature sensor 1310 and a humidity sensor 1320, and the at least one processor 210 may be further configured to execute the at least one instruction to, after initial installation of the air conditioner 100, collect environmental information about the target space detected by the temperature sensor 1310 and the humidity sensor 1320, and power consumption of the air conditioner 100, learn power consumption of the air conditioner according to an environment of the target space based on the collected environmental information and power consumption, and determine whether the air conditioner 100 is in the abnormal operation, based on an environmental condition of the target space for which the learning is completed.

According to an embodiment of the disclosure, the at least one processor 210 may be further configured to execute the at least one instruction to, based on the detected illuminance value being greater than or equal to the first illuminance reference value and a new human being detected in a state in which no human has been detected in the target space, output a first pattern of lighting and then control the light 114 in the first mode.

In addition, according to an aspect of an embodiment of the disclosure, a method of controlling an air conditioner is provided. The method of controlling an air conditioner includes detecting an illuminance value of a target space by using an illuminance sensor, determining whether the detected illuminance value is greater than or equal to a first illuminance reference value, detecting a human in the target space by using a sensor detection value of a detection sensor, and based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.

In addition, according to an embodiment of the disclosure, the method of controlling an air conditioner may further include, based on the detected illuminance value being less than or equal to a second illuminance reference value that is less than the first illuminance reference value, and a human being detected in the target space, controlling the light in a second mode in which the light is turned on at a first level of luminous intensity.

In addition, according to an embodiment of the disclosure, the luminous intensity change pattern may include at least one of a luminous intensity pattern, a light blinking period, a light blinking pattern, or a light width change.

In addition, according to an embodiment of the disclosure, the luminous intensity change pattern may correspond to a periodic dimming pattern.

In addition, according to an embodiment of the disclosure, the luminous intensity change pattern may correspond to a direction change pattern of the light 114.

In addition, according to an embodiment of the disclosure, the method of controlling an air conditioner may further include learning power consumption of the air conditioner according to an environment of the target space, based on power consumption of the air conditioner in a current environment being greater than the learned power consumption by a reference proportion, determining that the air conditioner is in an abnormal operation, and based on determining that the air conditioner is in the abnormal operation, providing an abnormal operation notification to a user.

In addition, according to an embodiment of the disclosure, the method of controlling an air conditioner may further include, based on the detected illuminance value being greater than or equal to the first illuminance reference value and a new human being detected in a state in which no human has been detected in the target space, outputting a first pattern of lighting and then controlling the light in the first mode.

In addition, according to an aspect of an embodiment of the present disclosure, provided is a computer-readable recording medium having recorded thereon a program for executing, on a computer, the method of controlling an air conditioner by detecting an illuminance value of a target space by using an illuminance sensor; determining whether the detected illuminance value is greater than or equal to a first illuminance reference value; detecting a human in the target space by using a sensor detection value of a detection sensor; and based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.

1. An air conditioner comprising:
a detection sensor configured to detect an object;
an illuminance sensor configured to detect an illuminance of a target space;
a light;
an air conditioning module comprising a compressor;
at least one processor including processing circuitry; and
a memory storing at least one instruction, when executed by the at least one processor individually or collectively, cause the air conditioner to:
determine whether an illuminance value detected by the illuminance sensor is greater than or equal to a first illuminance reference value,
detect a human in the target space by using a sensor detection value of the detection sensor, and
based on the detected illuminance value being greater than or equal to the first illuminance reference value and a human being detected in the target space, control the light in a first mode in which at least one of luminous intensity or a luminous intensity change pattern of the light is controlled based on a compressor frequency of the compressor of the air conditioning module.

2. The air conditioner of claim 1, wherein the at least one processor is further configured to execute the at least one instruction to, based on the detected illuminance value being less than or equal to a second illuminance reference value that is less than the first illuminance reference value, and a human being detected in the target space, control the light in a second mode in which the light is turned on at a first level of luminous intensity.

3. The air conditioner of claim 1, wherein the luminous intensity change pattern comprises at least one of a luminous intensity level pattern, a light blinking period, a light blinking pattern, or a turn-on section width change.

4. The air conditioner of claim 1, wherein the luminous intensity change pattern corresponds to a periodic dimming pattern.

5. The air conditioner of claim 1, wherein the luminous intensity change pattern corresponds to a direction change pattern of the light.

6. The air conditioner of claim 5, wherein the light comprises a line-shaped light-emitting diode (LED) light, and
the at least one processor is further configured to execute the at least one instruction to change a direction of the light by changing a turn-on section of the LED light over time.

7. The air conditioner of claim 1, wherein the at least one processor is further configured to execute the at least one instruction to adjust the luminous intensity of the light according to an ambient illuminance detected by the illuminance sensor.

8. The air conditioner of claim 1, wherein the at least one processor is further configured to execute the at least one instruction to learn power consumption of the air conditioner according to an environment of the target space, based on power consumption of the air conditioner in a current environment being greater than the learned power consumption by a reference proportion, determine that the air conditioner is in an abnormal operation, and based on determining that the air conditioner is in the abnormal operation, provide an abnormal operation notification to a user.

9. The air conditioner of claim 8, further comprising a temperature sensor and a humidity sensor,
wherein the environment of the target space is defined by at least one of an indoor temperature, an indoor humidity, an outdoor temperature, or an outdoor humidity.

10. The air conditioner of claim 8, further comprising a communication module,
wherein the at least one processor is further configured to execute the at least one instruction to provide the abnormal operation notification to an external device through the communication module.

11. The air conditioner of claim 8, further comprising a temperature sensor and a humidity sensor,
wherein the at least one processor is further configured to execute the at least one instruction to, after initial installation of the air conditioner, collect environmental information about the target space detected by the temperature sensor and the humidity sensor, and power consumption of the air conditioner, learn power consumption of the air conditioner according to an environment of the target space based on the collected environmental information and power consumption, and determine whether the air conditioner is in the abnormal operation, based on an environmental condition of the target space for which the learning is completed.

12. The air conditioner of claim 1, wherein the at least one processor is further configured to execute the at least one instruction to, based on the detected illuminance value being greater than or equal to the first illuminance reference value and a new human being detected in a state in which no human has been detected in the target space, output a first pattern of lighting and then control the light in the first mode.

13. A method of controlling an air conditioner, the method comprising:
detecting an illuminance value of a target space by using an illuminance sensor;
determining whether the detected illuminance value is greater than or equal to a first illuminance reference value;
detecting a human in the target space by using a sensor detection value of a detection sensor; and
based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.

14. The method of claim 13, further comprising, based on the detected illuminance value being less than or equal to a second illuminance reference value that is less than the first illuminance reference value, and a human being detected in the target space, controlling the light in a second mode in which the light is turned on at a first level of luminous intensity.

15. The method of claim 13, wherein the luminous intensity change pattern comprises at least one of a luminous intensity pattern, a light blinking period, a light blinking pattern, or a light width change.

16. The method of claim 13, wherein the luminous intensity change pattern corresponds to a periodic dimming pattern.

17. The method of claim 13, wherein the luminous intensity change pattern corresponds to a direction change pattern of the light.

18. The method of claim 13, further comprising:
learning power consumption of the air conditioner according to an environment of the target space;
based on power consumption of the air conditioner in a current environment being greater than the learned power consumption by a reference proportion, determining that the air conditioner is in an abnormal operation; and
based on determining that the air conditioner is in the abnormal operation, providing an abnormal operation notification to a user.

19. The method of claim 13, further comprising, based on the detected illuminance value being greater than or equal to the first illuminance reference value and a new human being detected in a state in which no human has been detected in the target space, outputting a first pattern of lighting and then controlling the light in the first mode.

20. A computer program product comprising a storage medium storing instructions configured to be executed by at least one processor of an electronic device to perform a plurality of operations comprising:
detecting an illuminance value of a target space by using an illuminance sensor;
determining whether the detected illuminance value is greater than or equal to a first illuminance reference value;
detecting a human in the target space by using a sensor detection value of a detection sensor; and
based on the detected illuminance value being greater than or equal to the first illuminance reference value and a human being detected in the target space, controlling an air conditioning module in a first mode in which at least one of luminous intensity or a luminous intensity change pattern of a light included in the air conditioner is controlled based on a compressor frequency of a compressor of the air conditioning module.
